(19) United States
(12) Patent Application Publication
(10) Pub. No.: US 2012/0184132 A1
(43) Pub. Date: Jul. 19, 2012

(54) DIRECT CURRENT OUTLET

(75) Inventors: Kazuhiro Katou, Osaka City (JP); Maki Kondou, Mie City (JP); Takashi Kawamoto, Mie City (JP); Toshiyuki Takii, Mie City (JP); Satoru Ueno, Osaka City (JP)

(73) Assignee: Panasonic Electric Works Co., Ltd., Osaka (JP)

(21) Appl. No.: 13/389,353

(22) PCT Filed: Aug. 2, 2010
(86) PCT No.: PCT/IB10/01892

§ 371 Date: Apr. 9, 2012

(30) Foreign Application Priority Data
Aug. 7, 2009 (JP) 2009-185057
Aug. 7, 2009 (JP) 2009-185059
Aug. 7, 2009 (JP) 2009-185060
Aug. 7, 2009 (JP) 2009-185280
Nov. 24, 2009 (JP) 2009-266751

(51) Int. Cl. H01R 13/60

(52) U.S. Cl. 439/535

(57) ABSTRACT

A plug is adapted to be connected to a DC outlet to supply a DC power to the plug. The plug includes plug pins and a substantially quadrangular-shaped surrounding wall for surrounding the plug pins. The DC outlet includes: an outlet main body having an outlet unit to which the plug is adapted to be connected. The outlet unit includes a plug-receiving portion having pin-inserting holes into which the plug pins are inserted; an insertion groove formed to surround a periphery of the plug-receiving portion, the insertion groove being adapted to receive the surrounding wall; and pin-receiving pieces for being connected with the plug pins that are respectively inserted through the pin-receiving holes. Two pin-receiving holes corresponding to the pin-receiving pieces are arranged along a reference side of the plug- receiving portion and offset closer to the reference side than an opposite side to the reference side.

### FIELD OF THE INVENTION

The present invention relates to a direct current (DC) outlet.

### BACKGROUND OF THE INVENTION

There has been known a DC outlet for supplying a DC power to an electric device, such as a radio and a telephone, a driving power source of which is a DC power source (see, e.g., Japanese Patent Application Publication No. H07-015835(JP07-015835A), paragraphs [0021] to [0023]).

The DC outlet of JP07-015835A includes a main body that is accommodated in a switch box provided inside a wall; and a converter provided inside the main body to convert an AC power to a DC power. Further, the DC outlet includes an AC connection terminal provided on a rear side of the main body which faces the switch box; and an outlet part provided on a front side of the main body which faces an inside of a room. A power line of an AC power source installed inside the wall is connected to the AC connection terminal, and a plug of an electric device is detachably connected to the outlet part. Accordingly, when the power line of the AC power source is connected to the AC connection terminal of the DC outlet, an AC power is converted to a DC power by the converter, so that the DC power can be supplied to the electric device having the plug that is connected to the outlet part thereof.

In the meantime, when a plug is connected to and disconnected from a DC outlet, an arc may be generated. Especially, in the case of the DC outlet for supplying a DC power, the generated arc may be maintained as compared with an AC outlet and, thus, the DC outlet needs an arc protecting unit. However, the DC outlet of JP07-015835A has an outlet part of a pin-jack type terminal and no member for surrounding plug pins of a plug. Accordingly, the generated arc may be seen from the outside.

As an example of a DC outlet including an arc protecting unit, there has been disclosed a plug and a socket of a safety extra low voltage (SELV) voltage standardized by the IEC standard (CEI/IEC 60906-3). FIGS. 37C and 37D show a plug 110 standardized by the IEC standard. Two plug pins 112 are arranged inside a cylindrical portion 111 provided at a front end portion of the plug 110.

Meanwhile, as shown in FIGS. 37A and 37B, a socket 100 includes a circular opening 101 through which the cylindrical portion 111 of the plug 110 is inserted; a cylindrical protruding portion 102 which protrudes from the circular opening 101 to be inserted into the cylindrical portion 111; pin-inserting holes 103 which are opened to an front end surface of the protruding portion 102; and pin-receiving pieces 104 provided inside the protruding portion 102 to communicate with the pin-inserting holes 103. When the plug 110 is connected to the socket 100, the plug pins 112 which are inserted into the protruding portion 102 through the pin-inserting holes 103 are respectively engaged with the pin-receiving pieces 104, so that a power is supplied from the socket 100 to the plug 110.

As shown in FIGS. 37A to 37D, in the socket 100 standardized by the IEC standard, the two pin-inserting holes 103 are opened on a line L1 extending through the center of the protruding portion 102 and at two symmetric positions with regard to the center of the protruding portion 102. For that reason, a keyway 105 is formed on a peripheral surface of the protruding portion 102 and a rib 113 is formed on an inner peripheral surface of the cylindrical portion 111 such that the plug pins 112 would not be inserted into the pin-inserting holes 103 in a state that their polarities are misaligned.

Further, the plug 110 and the socket 100 standardized by the IEC standard correspond to four kinds of supply voltages. To identify the kinds of supply voltages, the socket 100 and the plug 110 respectively include a voltage-identifying groove 106 formed on the peripheral surface of the protruding portion 102 at a predetermined angle with regard to the keyway 105; and a voltage-identifying rib 114 protrudently formed on the inner peripheral surface of the cylindrical portion 111 of the plug 110 at a predetermined angle with regard to the rib 113.

Then, the plug 110 is prevented from being inserted into the socket 100 reversely or wrongly with their polarities misaligned by engaging the keyway 105 and the voltage-identifying groove 106 with the rib 113 and the voltage-identifying rib 114, respectively. When, however, the cylindrical portion 111 is inserted into the circular opening 101, it is required to find positions at which the ribs 113 and 114 of the cylindrical portion 111 are respectively engaged with the keyway 105 and the groove 106 of the socket 100 while rotating the plug 110. Accordingly, it becomes inconvenient to use the socket 100 and the plug 110.

To prevent the plug 110 from being reversely inserted into the socket 100 without using the keyway 105 and the rib 113, it is considered to arrange the two pin-inserting holes 103 at a side below or above the line L1 (e.g., at a side below the line L1 as shown in FIG. 37A by the dotted line). Since, however, the protruding portion 102 has the cylindrical shape, the distance between the pin-inserting holes 103 becomes closer when the pin-inserting holes 103 are arranged at a side below or above line L1. Accordingly, the socket 100 becomes scaled up in order to obtain an insulating distance.

### SUMMARY OF THE INVENTION

In view of the above, the present invention provides a DC outlet capable of preventing a plug from being reversely inserted thereto without being scaled up and easily aligning the plug therewith when the plug is connected thereto.

In accordance with an aspect of the present invention, there is provided a direct current (DC) outlet to which a plug is adapted to be connected to supply a DC power to the plug, the plug including a plurality of plug pins having a circular bar shape; and a substantially quadrangular-shaped surrounding wall for surrounding the plug pins. The DC outlet includes: an outlet main body having an outlet unit to which the plug is adapted to be connected, the outlet unit being provided in a front surface of the outlet main body. The outlet unit includes a plug-receiving portion having a plurality of pin-inserting holes into which the plug pins of the plug are inserted, the plug-receiving portion having a substantially quadrangular shape viewed from the front thereof; an insertion groove formed to surround a periphery of the plug-receiving portion, the insertion groove being adapted to receive the surrounding wall of the plug; and pin-receiving pieces for being connected with the plug pins that are respectively inserted through the pin-receiving holes. Two of the pin-receiving holes corresponding to the pin-receiving pieces for supplying a DC power are arranged along one side of the plug-receiving portion serving as a reference side and offset closer to the reference side than an opposite side to the reference side.

A shape of at least one of the plug-receiving portion and the insertion groove, viewed from the front thereof, may be partially changed depending on the kinds of a supply voltage or a supply current.

The shape of the insertion groove viewed from the front may be changed such that an area of the plug-receiving portion is decreased as compared with a case that the plug-receiving portion has the substantially quadrangular shape viewed from the front.

The shape of the insertion groove viewed from the front may be changed differently depending on the kinds of the supply voltage or the supply current by cutting at least one side of the substantially quadrangular shape of the plug-receiving portion depending on the kinds of the supply voltage or the supply current, and forming the insertion groove along an outer periphery of the plug-receiving portion.

A portion of the insertion groove whose shape is changed depending on the kinds of the supply voltage or the supply current may be closer to the opposite side to the reference side than the reference side.

The shape of the insertion groove viewed from the front may be changed such that an area of the plug-receiving portion is increased as compared with a case that the plug-receiving portion has the substantially quadrangular shape viewed from the front.

The shape of the insertion groove viewed from the front may be changed by forming an extension groove extending from the insertion groove. In this case, the extension groove may be formed by extending a part of the insertion groove into the plug-receiving portion, and the extension groove may be provided closer to the opposite side to the reference side of the plug-receiving portion than the reference side.

Alternatively, the extension groove may be formed on the front surface of the outlet main body by outwardly extending a part of the insertion groove.

A shape of at least one of the plug-receiving portion and the insertion groove, viewed from the front thereof, may be partially changed depending on the kinds of a power supply circuit serving as a power supply source.

In this case, the shape of the insertion groove viewed from the front may be partially changed only when the power supply circuit is a safety extra low voltage (SELV) circuit.

The plug pins of the plug may include a ground pin, and the pin-inserting holes of the plug-receiving portion may include a ground pin inserting hole into which the ground pin of the plug is inserted. In this case, the ground pin inserting hole may be provided offset closer to the opposite side to the reference side.

In accordance with embodiments of the present invention, the outlet unit includes the plug-receiving portion having the substantially quadrangularly shape viewed from the front surface, the periphery of which is surrounded by the insertion groove. In the plug-receiving portion, two pin-inserting holes corresponding to the pin-receiving pieces for supplying the DC power are arranged along one side of the plug-receiving portion serving as the reference side and offset closer to the reference side of the plug-receiving portion. Accordingly, it is possible to easily recognize an orientation of the plug to be inserted into the outlet unit. In addition, since the orientation of the plug to be inserted into the outlet unit is restricted by the substantially quadrangularly shaped surrounding wall of the plug to be inserted into the insertion groove provided around the substantially quadrangularly shaped plug-receiving portion, it is possible to embody the DC outlet capable of easily performing position alignment, preventing the reverse insertion, and being conveniently used. Further, the plug-receiving portion has the substantially quadrangularly shape. Accordingly, even when two pin-inserting holes are arranged offset closer to the reference side, it is possible to obtain a sufficient insulation distance without reducing the distance between the pin-inserting holes, to thereby prevent the DC outlet from being scaled up.

Besides, an outer peripheral shape of the plug-receiving portion is changed differently depending on the kinds of the supply voltage. Accordingly, it is possible to prevent the wrong insertion of the plug having different voltage and easily discriminate the kinds of the supply voltage from the outer peripheral shape of the plug-receiving portion. In addition, since an outer peripheral shape of the plug is changed differently as the outer peripheral shape of the plug-receiving portion is changed differently depending on the kinds of the supply voltage, it is possible to easily recognize the orientation of the corresponding plug to be inserted to the DC outlet and easier insert the plug into the DC outlet. Finally, the plug-receiving portion has the outer peripheral quadrangular shape with at least one corner cut. Accordingly, it is possible to prevent the DC outlet from being scaled up without protruding the plug-receiving portion to the outer side of the substantially quadrangular shape.

### BRIEF DESCRIPTION OF THE DRAWINGS

The objects and features of the present invention will become apparent from the following description of embodiments, given in conjunction with the accompanying drawings, in which:

FIG. 1 is a perspective view showing the outer appearances of a plug and a DC outlet in accordance with a first embodiment of the present invention before the plug is connected to the DC outlet;

FIGS. 2A to 2C are a front view, a right side view, and a partial bottom section view, respectively, showing the DC outlet;

FIG. 3 is a perspective view showing the outer appearances of a mounting frame and the DC outlet in accordance with the first embodiment of the present invention;

FIG. 4 is a perspective view showing the outer appearance of the plug to be connected to the DC outlet;

FIGS. 5A and 5B are front views showing an installation state of the DC outlet;

FIGS. 6A to 6D are front views showing an installation state of the DC outlet;

FIGS. 7A to 7E are front views showing a DC outlet in accordance with a second embodiment of the present invention;

FIGS. 8A to 8D are front views showing a DC outlet in accordance with a third embodiment of the present invention;

FIG. 9 is a front view showing an installation state of the DC outlet;

FIG. 10 shows a structure of a DC power distribution system employing the DC outlet;

FIGS. 11A to 11D are front views showing a DC outlet corresponding to four supply voltages, i.e., 6, 12, 24 and 48 V, respectively, in accordance with a fourth embodiment of the present invention;

FIG. 12 is a perspective view showing an outer appearance of the plug to be connected to the DC outlet of the fourth embodiment;

FIGS. 13A to 13F are front views showing a DC outlet in accordance with a fifth embodiment of the present invention, wherein the shapes of a plug-receiving portion and a receiving groove are changed depending on the kinds of the supply voltage;

FIG. 14 is a perspective view showing an outer appearance of the plug to be connected to the DC outlet of the fifth embodiment;

FIGS. 15A to 15C are a perspective view, a front view and a bottom view showing a DC outlet in accordance with a sixth embodiment of the present invention;

FIGS. 16A to 16C are front views showing the DC outlet of the sixth embodiment, wherein the shapes of a plug-receiving portion and a receiving groove are changed depending on the kinds of the supply current;

FIGS. 17A to 17D are front views showing the DC outlet of the sixth embodiment, wherein the shapes of the plug-receiving portion and the receiving groove are changed depending on the kinds of the supply voltage;

FIGS. 18A and 18B are a perspective view and a front view showing an outer appearance of the plug to be connected to the DC outlet of the sixth embodiment;

FIG. 19A is a perspective view showing the DC outlet and the plug of the sixth embodiment which are to be connected;

FIG. 19B is a front view of the DC outlet of the sixth embodiment which explains the case the plug is reversely connected to the DC outlet;

FIGS. 20A to 20D are front views showing installation states of the DC outlets of the sixth embodiment;

FIG. 21 is a perspective view showing a modification of the DC outlet of the sixth embodiment;

FIG. 22 is a perspective view showing another modification of the DC outlet of the sixth embodiment;

FIGS. 23A and 23B are perspective view showing still other modifications of the DC outlet of the sixth embodiment;

FIGS. 24A to 24C are front views showing a DC outlet in accordance with a seventh embodiment of the present invention, wherein the shapes of the plug-receiving portion and the receiving groove are changed depending on the kinds of the power supply circuit;

FIGS. 25A and 25B are perspective views showing outer appearances of the plugs to be connected to the DC outlets of the seventh embodiment;

FIG. 26 is a front view showing still another modification of the DC outlet of the seventh embodiment;

FIGS. 27A to 27C are front views showing a DC outlet in accordance with an eighth embodiment of the present invention, wherein the shapes of the plug-receiving portion and the receiving groove are changed depending on the kinds of the power supply circuit;

FIGS. 28A and 28B are front views showing a modification of the DC outlet of the eighth embodiment;

FIG. 29 is a front view showing an installation state of the DC outlet of the eighth embodiment;

FIGS. 30A and 30B are a perspective view and a front view showing a DC outlet in accordance with a ninth embodiment of the present invention;

FIGS. 31A and 31B are a perspective view and a front view showing an outer appearance of the plug to be connected to the DC outlet of the ninth embodiment;

FIGS. 32A to 32D are front views showing the DC outlet of the ninth embodiment, wherein the shapes of the plug-receiving portion and the receiving groove are changed depending on the kinds of the supply voltage;

FIGS. 33A to 33B are front views showing the DC outlet of the ninth embodiment, wherein the shapes of the plug-receiving portion and the receiving groove are changed depending on the kinds of the power supply circuit;

FIGS. 34A to 34E are front views showing modifications of the DC outlet of the ninth embodiment;

FIGS. 35A to 35B are front views showing modifications of the DC outlet of the ninth embodiment;

FIG. 36A and 36B are explanatory views showing a case where a flat-blade shaped plug pins are inserted into pin-inserting holes in the DC outlet; and

FIGS. 37A to 37D show a socket and a plug for a safety extra low voltage (SELV) voltage standardized by the IEC standard, wherein FIGS. 37A and 37B are a front view and a cross sectional view of the socket and FIGS. 37C and 37D are a front view and a cross sectional view of the plug.

### DETAILED DESCRIPTION OF THE EMBODIMENTS

Embodiments of the present invention will now be described with reference to the accompanying drawings which form a part hereof.

In the embodiments, a wall-buried DC outlet is taken for an example. The present invention may be applied to a an outlet such as an outlet fixed to an electric device, a code connector body used for extending connection of a code without being fixed, and a unfixed multi-outlet power strip and the like.

### First Embodiment

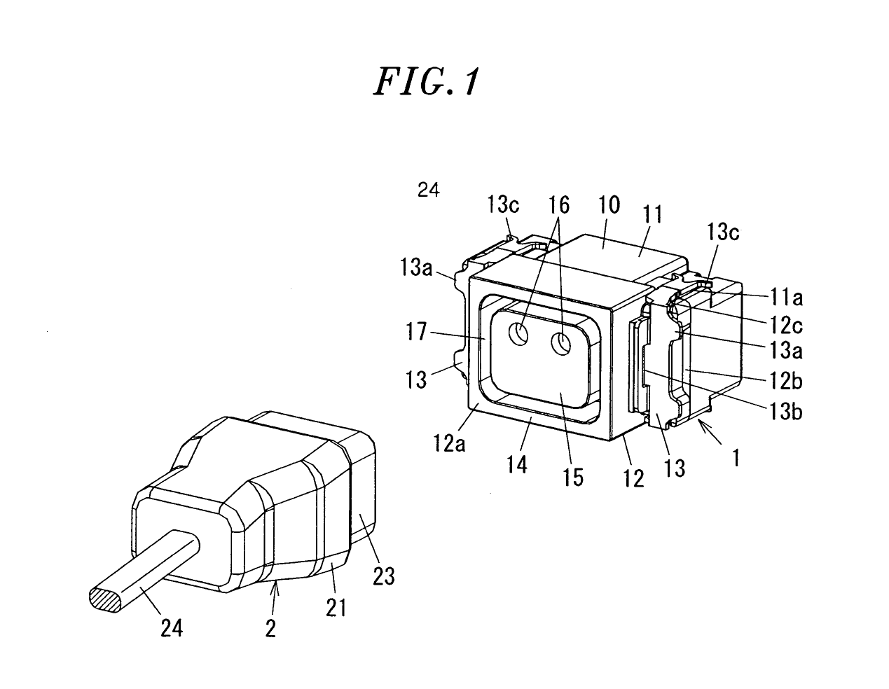

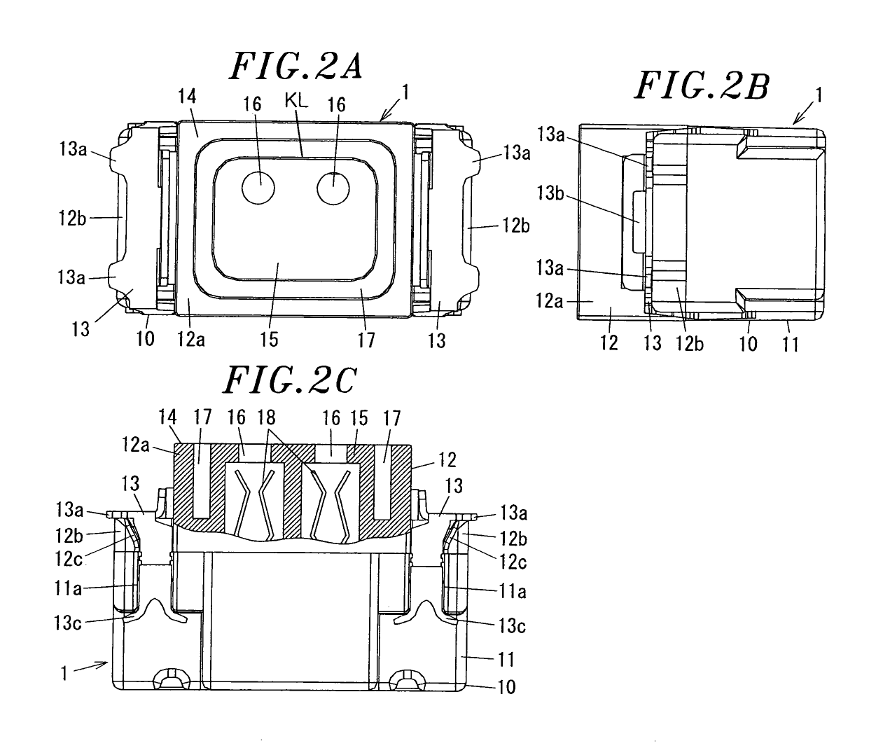

A first embodiment of the present invention will be described with reference to FIGS. 1 to 6D. A DC outlet of the first embodiment is buried in a construction surface such as a wall. The DC outlet 1 and a plug 2 that is, e.g., detachably connected to the DC outlet 1 constitute a plug connector for a DC power. Unless otherwise described, upward, downward, left and right directions of the DC outlet 1 are defined based on FIG. 2A. FIG. 2A shows the front side of the DC outlet 1 and the right side of FIG. 2B indicates the rear side of the DC outlet 1.

The DC outlet 1 includes an outlet main body 10 buried in a construction surface, the outlet main body 10 being made of a synthetic resin material. The outlet main body 10 includes a substantially rectangular body 11 with a front side opened and a substantially rectangular cover 12 with a rear side opened, which are assembled together by an assembling frame 13. The body 11 and the cover 12 are made of a synthetic resin material, and the assembling frame 13 is made of a metal material.

The outlet main body 10 has a size conforming to Japanese Industrial Standard (see JIS C 8303). The outlet main bodies 10 has one module dimension, and three outlet main bodies can be attached side by side to a mounting frame for interchanging wring devices of large square boss type (see JIS C 8375).

On a front surface of the cover 12, a boss 12a is forwardly protruded therefrom as a single unit to be fixed in an opening 54 of a mounting frame 50. A central portion of the substantially U-shaped assembling frame 13 is mounted in each of shoulders 12b provided at opposite end sides of the boss 12a. Opposite end sides of the assembling frame 13 are respectively inserted into engaging recesses 12c and 11a formed at side surfaces of the cover 12 and the body 11, and substantially V-shaped engaging claws 13c provided at leading end portions of the opposite end sides of the assembling frame 13 are respectively expanded to be engaged with the opposite end portions of the engaging recess 11a. Accordingly, the body 11 and the cover 12 are combined by the assembling frame 13.

Protrudently provided at an outer peripheral portion of a central portion of the assembling frame 13 is a pair of engaging claws 13a capable of being engaged with engaging openings provided on the mounting frame 50 made of a synthetic resin material. Further, engaging openings 13b are provided at a protruding portion forwardly protruding from an inner peripheral portion of the central portion of the assembling frame 13 to be engaged with engaging claws of a mounting frame (not shown) made of a metal material when being installed in the mounting frame.

Provided on a front surface of the boss 12a is an outlet unit 14 to which the plug 2 is detachably connected. Specifically, the outlet unit 14 is provided at a central portion of the front surface of the boss 12a. The outlet unit 14 has a substantially quadrangular shape viewed from the front thereof and includes a plug-receiving portion 15 in which two circular pin-inserting holes 16 are formed; an insertion groove 17 formed to surround the plug-receiving portion 15 so as to receive a surrounding wall 23 of the plug 2; and two pin-receiving pieces 18 for being respectively engaged with plug pins 22 of the plug 2 inserted into the outlet main body 10 through the pin-inserting holes 16.

Specifically, the two pin-inserting holes 16 are provided to correspond to the two (positive and negative) pin-receiving pieces 18 for supplying a DC power. The pin-inserting holes 16 are arranged along a side, e.g., an upper side, in the present embodiment, serving a reference side KL, of the plug-receiving portion 15 and closer to the upper side (the reference side KL) of the plug-receiving portion 15 than a lower side thereof opposite to the reference side KL.

In addition, a distance between the upper side of the plug-receiving portion 15 and the pin-inserting holes 16 is ½ or less of a distance between the pin-inserting holes 16 and the lower side thereof. Further, it is easily recognized that the pin-inserting holes 16 are arranged closer to the upper side of the plug-receiving portion 15.

Received into the outlet main body 10 are connection terminals (not shown) of so-called quick connection terminal structure to be respectively electrically connected to the pin-receiving pieces 18. A power supply line (not shown) of a DC power supply is inserted through a line-inserting hole opened at a rear side of the body 11 to be connected to the connection terminal. Further, the conventional quick connection terminal disclosed in the Japanese Patent Application Publication No. H10-144424, for example, may be employed as the connection terminals (not shown) of quick connection terminal structure, and the description and illustration thereof will be omitted.

FIG. 3 shows the DC outlet 1 and the mounting frame 50 before the DC outlet 1 is mounted in the mounting frame 50 made of a synthetic resin material. The mounting frame 50 has installation pieces 51 at its longitudinally opposite ends. Each of the installation pieces 51 includes a long hole 52 for a box screw; an attachment hole (not shown) for attachment of a clamping bracket; and a screw hole 53 for a plate screw.

Three sets of engaging holes (not shown) are formed in one longitudinal side piece 55, one set being constituted by two engaging holes, and a longitudinally extending plate piece 57 is installed hanging down in the other longitudinal side piece 56. Three engaging holes 59 are formed in the plate piece 57 in the longitudinal direction, and a protruding piece 58 is installed protruding from each of the engaging holes 59 upwardly.

When the DC outlet 1 is buried and installed on a construction surface through the mounting frame 50, the engaging claws 13a of the assembling frame 13 provided at one side of the DC outlet 1 are first respectively inserted into the engaging holes (not shown) provided in the side piece 55 of the mounting frame 50. Then, the engaging holes 13a of the assembling frame 13 provided at the other side of the DC outlet 1 are respectively inserted into the engaging holes 59 while being placed on opposite shoulders 58a of the respective protruding pieces 58. In this way, the outlet main body 10 is mounted in the mounting frame 50 while exposing the front surface of the boss 12a through the opening 54.

Next, a power supply line from a power supply is drawn into the inside through a burying hole that is opened to the construction surface and an uncovered central line of the power supply line is inserted through the line-inserting hole provided in a rear surface of the body 11 to electrically connect the power supply line to the terminal. Moreover, the mounting frame 50 is fixed on the construction surface by burying a rear portion of the outlet main body 10, to thereby allow the outlet main body 10 of the DC outlet 1 to be fixed on the construction surface through the mounting frame 50.

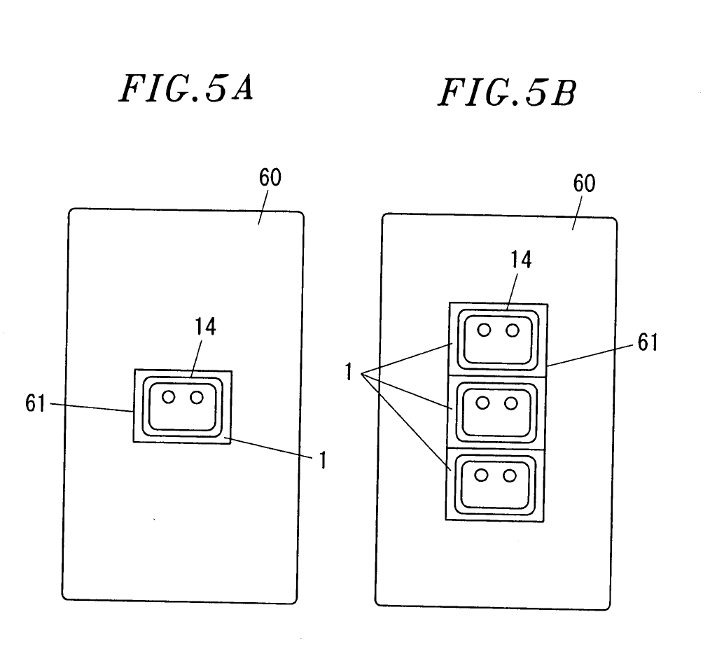

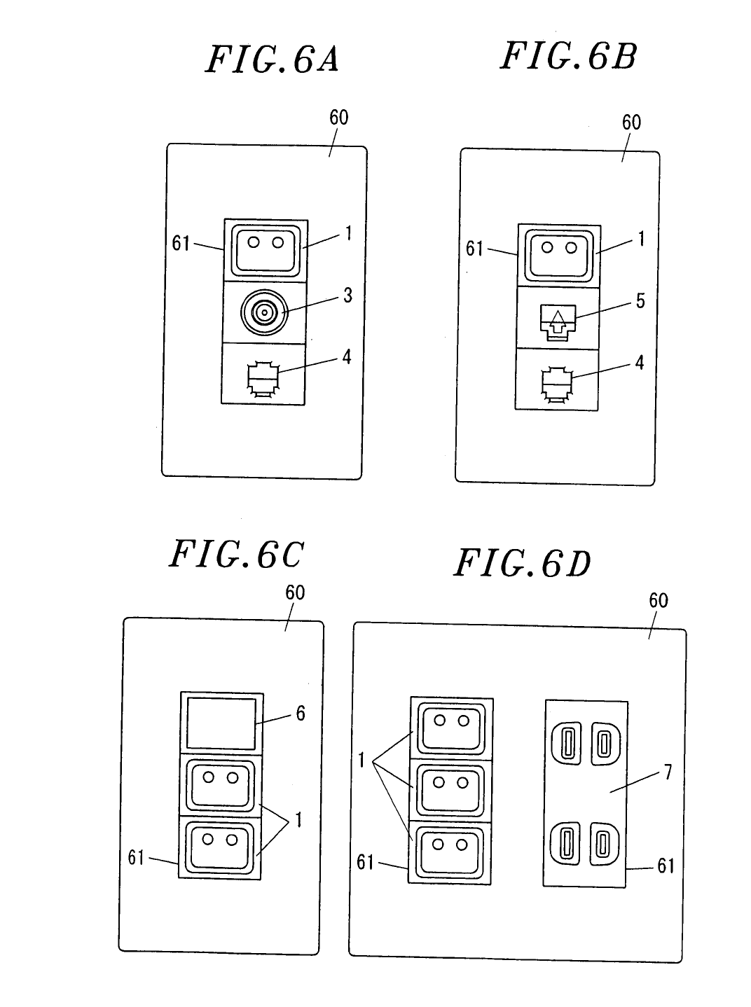

As shown in FIG. 5A, a decoration plate 60 is provided on a front surface of the mounting frame 50, and the outlet unit 14 of the DC outlet 1 is exposed through a window opening 61 formed in the decoration plate 60. Further, since the outlet main body 10 of the DC outlet 1 may be formed to have one module dimension, three DC outlets 1 may be mounted in the mounting frame 50 as shown in FIG. 5B. As shown in FIGS. 6A to 6C, the DC outlet may be mounted in the mounting frame 50 together with other wiring devices.

Specifically, in FIG. 6A, the DC outlet 1, a TV outlet 3, and a LAN modular outlet 4 are installed together in the mounting frame 50. In FIG. 6B, the DC outlet 1, the LAN modular outlet 4, and a phone modular outlet 5 are installed together in the mounting frame 50. In FIG. 6C, two DC outlets 1 and a wiring device 6 such as a pilot lamp are installed together in the mounting frame 50. Further, in FIG. 6D, an AC outlet 7 formed to have three module dimension are installed in one of two mounting frames 50, and three DC outlets 1 formed to have one module dimension are installed in the other mounting frame 50.

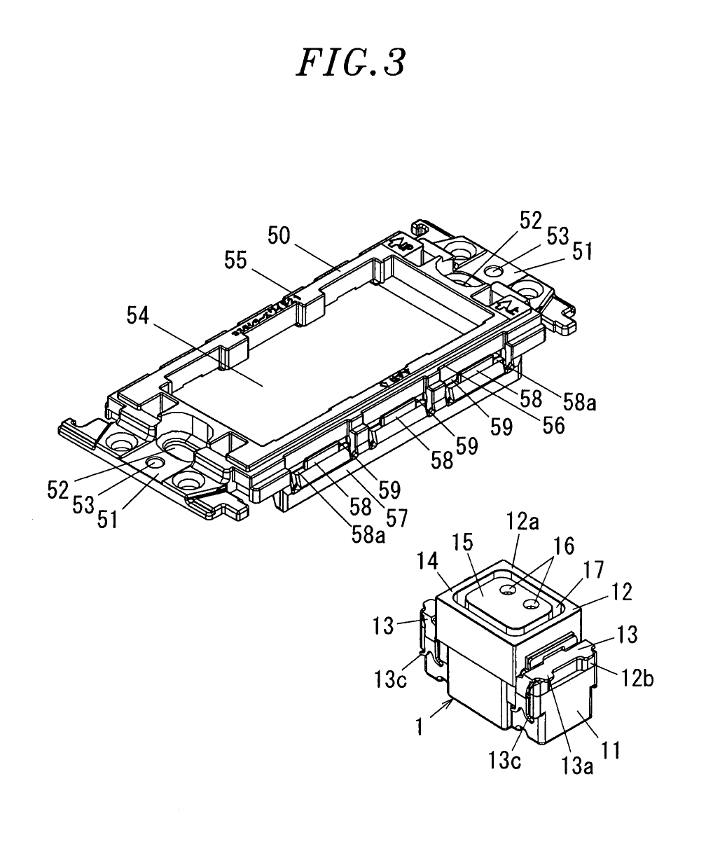

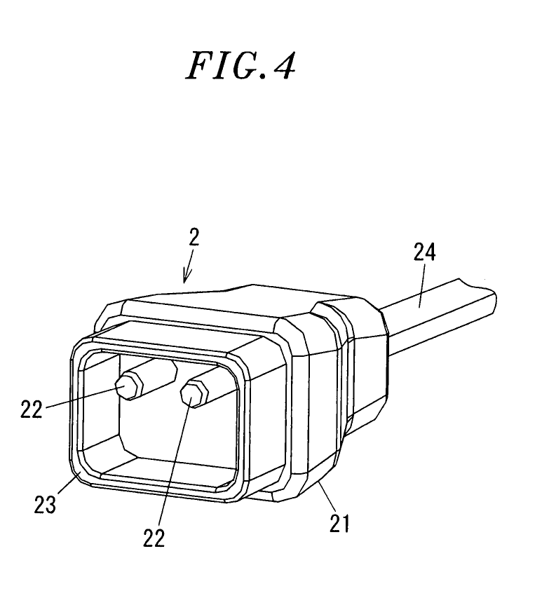

In the meantime, as shown in FIG. 4, the plug 2 connected to the DC outlet 1 includes a horizontally longer rectangular shaped plug main body 21 made of a synthetic resin material and having a size that is enough to grip by a hand. On a front surface (facing the DC outlet) of the plug main body 21, two circular bar shaped plug pins 22 are protrudently provided and the rectangularly tubular surrounding wall 23 is provided to surround the two plug pins 22. Here, a distance between the front surface of the plug main body and the leading end of the surrounding wall 23 is set to slightly longer than a distance between the front surface of the plug main body and the leading ends of the plug pins 22. In addition, the two plug pins 22 are arranged along a side (e.g., an upper side) of the surrounding wall 23 such that a distance between the plug pins 22 and the upper side of the surrounding wall 23 becomes smaller than a distance between the plug pins 22 and a lower side of the surrounding wall 23. Meanwhile, a cable 24 from a rear surface of the plug main body 21 is connected to a load device (not shown). Accordingly, when the plug 2 is connected to the DC outlet 1, a DC power is supplied to the load device through the cable 24.

When the plug 2 is connected to the DC outlet 1, the plug 2 first approaches the DC outlet 1 such that the plug pins 22 are aligned with the pin-inserting holes 16. Then, the surrounding wall 23 of the plug 2 is inserted into the insertion groove 17 of the DC outlet 1, and the plug pins 22 are fitted into the pin-inserting holes 16. Thereafter, the plug 2 continuously reaches a predetermined position to thereby engage the plug pins 22 with the pin-receiving pieces 18 electrically and mechanically. In addition, when the plug pins 22 are engaged to pin-receiving pieces 18, the front end portion of the surrounding wall 23 has been inserted into the insertion groove 17. Accordingly, even when an arc is generated during the engagement of the plug pins 22, the generated arc is not seen from the outside.

When the plug 2 is disconnected from the DC outlet 1, the plug 2 is first gripped and pulled out. Then, the plug pins 22 are disengaged from the pin-receiving pieces 18 and the pin-inserting holes 16. Thereafter, the surrounding wall 23 of the plug 2 is separated out from the insertion groove 17, to thereby disconnect the plug 2 from the DC outlet 1 easily. In addition, when the plug pins 22 are disengaged from the pin-receiving pieces 18, the leading end of the surrounding wall 23 has still been inserted into the insertion groove 17. Accordingly, even when an arc is generated during the disengagement of the plug pins 22, the generated arc is not seen from the outside.

In the DC outlet 1 of the present embodiment, the plug-receiving portion 15 to be inserted into the surrounding wall 23 of the plug 2 has the rectangular shape, and the two plug pins 22 opened to the plug-receiving portion 15 are arranged along and closer to the upper side (reference side) KL of the plug-receiving portion 15 such that the distance between the plug pins 22 and the upper side KL becomes smaller than the distance between the plug pins 22 and the lower side (opposite to the reference side KL) of the plug-receiving portion 15. Accordingly, it is possible to easily recognize an orientation of the plug 2 to be connected to the outlet unit 14.

Further, the orientation of the plug 2 to be connected to the outlet unit 14 is restricted by the rectangularly tubular surrounding wall 23 of the plug 2 to be inserted into the insertion groove 17 provided around the plug-receiving portion 15. Accordingly, it is possible to embody the DC outlet 1 capable of easily performing position alignment, preventing the reverse insertion, and being conveniently used, as compared with a socket of the SELV circuit, standardized by the IEC standard, with a circular engaged part.

In addition, in the outlet unit 14, since the insertion groove 17 is merely provided around the plug-receiving portion 15 to which the pin-inserting holes 16 are opened without the keyway differently from the socket of SELV circuit standardized by the IEC standard, it is possible to simplify the shape of the outlet unit 14 with satisfactory strength without causing the DC outlet 1 to be scaled up.

In case that the plug-receiving portion 15 has a circular shape viewed from the front thereof, when the two pin-inserting holes 16 are arranged closer to a side of the plug-receiving portion 15, the distance between the pin-inserting holes 16 becomes closer. Since, however, the plug-receiving portion 15 has the substantially quadrangular (e.g., rectangular) shape viewed from the front thereof in the present embodiment, the pin-inserting holes 16 does not becomes closer even when the pin-inserting holes 16 are arranged offset closer to the upper side, i.e., the reference side KL. Accordingly, it is possible to obtain a satisfactory insulation distance without causing the DC outlet 1 to be scaled up.

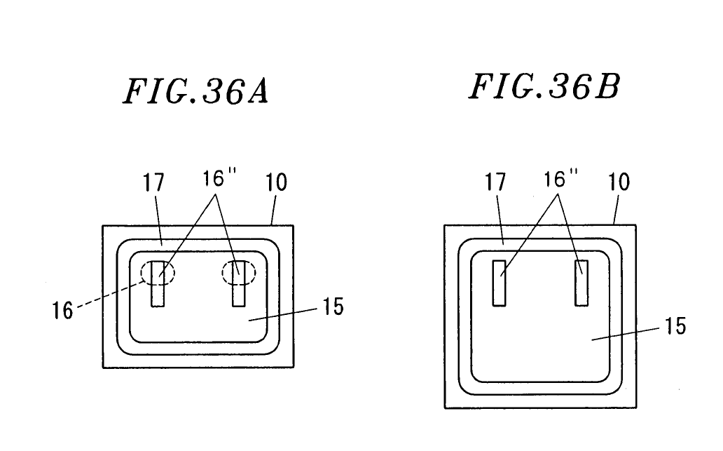

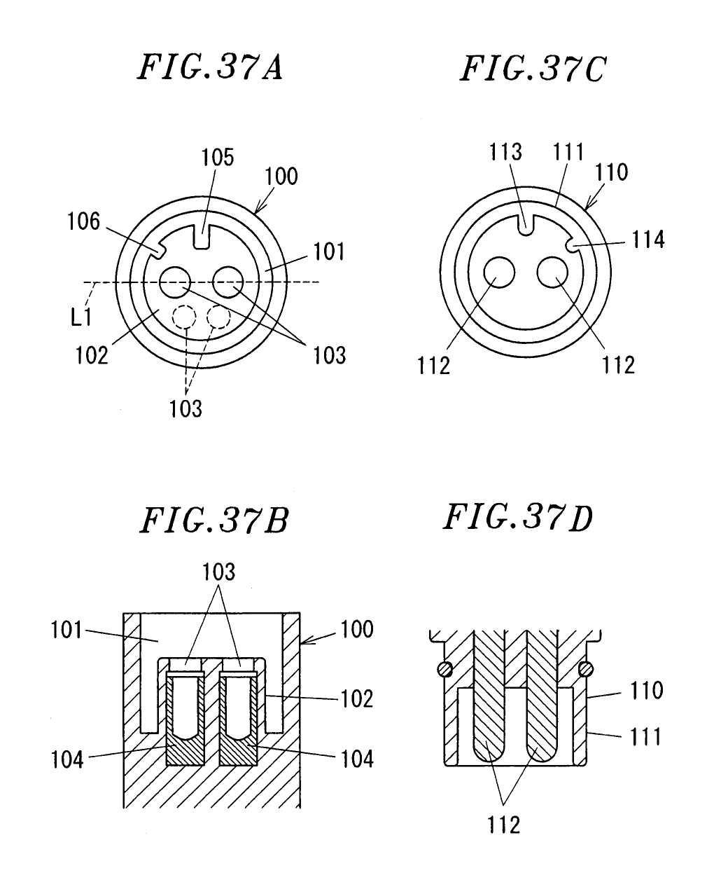

In the plug-in connection device, of the present embodiment, flat-blade shaped plug pins may be provided in the plug 2 instead of the circular bar shaped plug pins 22, and rectangular pin-inserting holes 16″ may be formed in the plug-receiving portion 15 as shown in FIG. 36A. In this case, cross section areas of the flat-blade shaped plug pins are required to be identical to those of the circular bar shaped plug pins 22. Accordingly, the plug pins have a narrow width and a horizontally long length. For that reason, as shown in FIG. 36A, the pin-inserting holes 16″ formed in the plug-receiving portion 15 also have a horizontally long length as compared with the circular pin-inserting holes 16.

When the outlet main body 10 is formed to have one module dimension, a difference between a longitudinal dimension (up-down directional dimension) of the pin-inserting holes 16″ and the up-down directional dimension of the circular pin-inserting holes 16 is small. Accordingly, although the pin-inserting holes 16″ are arranged offset closer to the upper side of the plug-receiving portion 15 in the up-down direction thereof with regard to the central position of the plug-receiving portion 15, it is difficult to obtain a large offset amount of the pin-inserting holes 16″ and, thus, it is also difficult to recognize whether the pin-inserting holes 16″ are arranged offset closer to the upper or the lower side of the plug-receiving portion 15.

Further, the pin-inserting holes 16″ are formed slightly longer than the longitudinal dimension of the flat-blade shaped plug pins. Accordingly, in case that the offset amount in the up-down direction of opening positions of the pin-inserting holes 16″ is small, when the plug 2 is inserted into the DC outlet in the reverse direction, end portions of the flat-blade shaped plug pins may reversely be inserted into the pin-inserting holes 16″. For that reason, it is required to increase the offset amount in the up-down direction of the opening positions of the pin-inserting holes 16″ as shown in FIG. 36B. This, however, causes the outlet main body 10 to be scaled up.

On the contrary, since the pin-inserting holes 16 have the circular shape in the present embodiment, it is possible to increase the offset amount in the up-down direction of the opening positions of the pin-inserting holes 16 as compared with the rectangular pin-inserting holes 16″. Accordingly, it is easy to recognize whether the pin-inserting holes 16 are arranged offset closer to the upper or the lower side thereof. Further, when the plug 2 is inserted into the DC outlet in the reverse orientation, the plug pins 22 of the plug 2 would not be inserted into the pin-inserting holes 16.

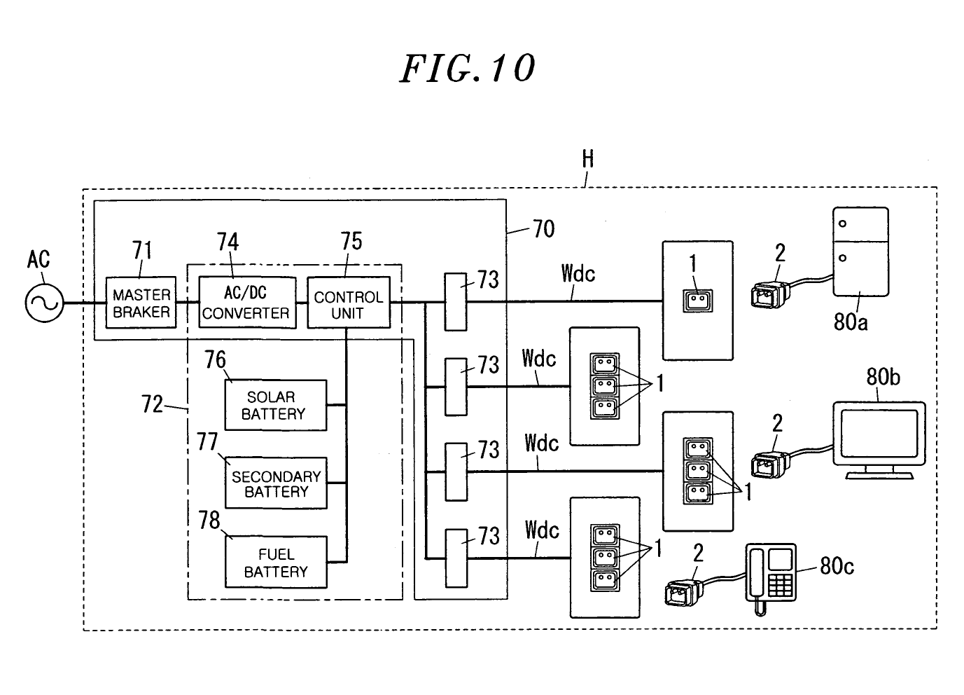

Meanwhile, the DC outlet 1 of the present embodiment is employed in a DC power distribution system shown in FIG. 10. FIG. 10 shows an example in which the DC power distribution system is applied to a detached house H. Alternatively, the DC power distribution system may be applied to a multi-family attached house or a building, such as a tenant building.

In the house H, a DC power supply unit 72 for outputting a DC power; the DC outlets 1, provided at necessary positions, to which a DC power is supplied through DC supply lines Wdc; and a plurality of electric devices (e.g., a refrigerator 80a, a TV 80b, and a phone 80c) that are operated by the DC power are installed. The DC power is supplied to the electric devices 80a to 80c by connecting outlet plugs of the electric devices 80a to 80c to the DC outlets 1. Further, DC breakers 73 are respectively provided between the DC power supply unit 72 and the DC outlets 1 in order to monitor currents flowing through the DC supply lines Wdc and restrict or interrupt the power supply from the DC power supply unit 72 to the DC outlets 1 through the DC supply lines Wdc when detecting an abnormality.

The DC power supply unit 72 typically converts into a DC power an AC power supplied from an AC power source AC, e.g., a commercial power source, outside the house H. In FIG. 10, the DC power supply unit 72 includes an AC/DC converter 74 and a control unit 75, and the AC power is inputted to the AC/DC converter 74 including a switching power source through a master breaker 71 provided in a power distributor 70. The converted DC power is inputted to the respective DC breakers 73 through the control unit 75.

The DC power supply unit 72 further includes a secondary battery 77 to prepare for a time during which no power is supplied from the AC power source AC (e.g., the blackout of the AC power source AC). A fuel battery 78 and/or a solar battery 76 for generating a DC power may be employed together in addition to the secondary battery 77. In this case, with respect to a major power source including the AC/DC converter 74 for generating a DC power by using an AC power supplied from the AC power source AC, the solar battery 76, the secondary battery 77 and/or the fuel battery 78 serve as decentralized power sources. In addition, each of the solar battery 76, the secondary battery 77 and the fuel battery 78 includes a circuit unit for controlling an output voltage. Further, the secondary battery 77 includes a circuit unit for controlling a charging as well as the circuit unit for controlling an output voltage.

The electric devices 80a to 80c need a plurality of kinds of voltages depending on device types. For that reason, the control unit 75 preferably includes a DC/DC converter for converting a specific voltage supplied from the major and the decentralized power sources into necessary voltages to respectively supply the converted voltage to corresponding DC outlets 1. The supply voltages of the DC power may adequately be determined depending on the electric devices and/or the use environment of a building. Here, a power supply circuit of the power supply source for supplying a DC power to the DC outlet 1 is provided between the AC power supply source AC and the DC outlet 1, e.g., inside the power distributor 70.

### Second Embodiment

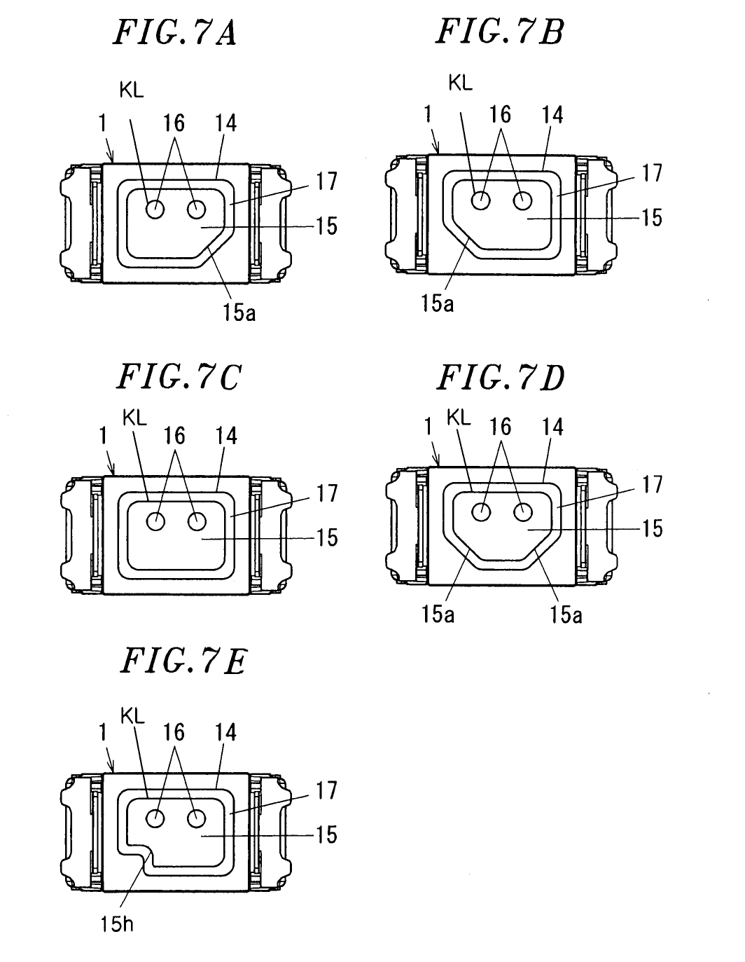

A second embodiment of the present invention will be described with reference to FIG. 7. In the first embodiment, the plug-receiving portion 15 has the substantially quadrangular (rectangular) shape viewed from the front thereof. On the other hand, in the second embodiment, the plug-receiving portion 15 has the substantially quadrangular (rectangular) shape with at least one corner cut depending on the kinds of the supply voltage, viewed from the front. Since the confiuration of the second embodiment is substantially identical to that of the first embodiment except for the shape of the plug-receiving portion 15, the components having substantially the same configuration and function are denoted by like reference characters and redundant description thereof will be omitted herein.

There is a plurality of electric devices requiring supply voltages, e.g., 6, 12, 24, 48 V. In case that a supply voltage of a DC outlet to be connected to an electric device is higher than that of the electric device, the insulation part of a plug of the electric device may be damaged or the temperature of the plug may be increased. On the other hand, in case that the supply voltage of the DC outlet is lower than that of the electric device, the performance of the electric device may be deteriorated.

The DC outlet 1 of the present embodiment receives, e.g., four kinds of voltages of DC 6, 12, 24, and 48 V. FIGS. 7A, 7B, 7C, and 7D show the DC outlets of 6, 12, 24, and 48 V, respectively. Specifically, in the DC outlet 1 of 6 V, the plug-receiving portion 15 has the substantially quadrangular (rectangular) shape with an inclined side 15a formed by obliquely cutting the right lower corner. The insertion groove 17 also has a shape conforming to the shape of the plug-receiving portion 17. In addition, in the DC outlet 1 of 12 V, the plug-receiving portion 15 has the substantially quadrangular (rectangular) shape with an inclined side 15a formed by obliquely cutting the left lower corner. The insertion groove 17 also has a shape conforming to the shape of the plug-receiving portion 17.

In the DC outlet 1 of 24 V, the plug-receiving portion has the substantially quadrangular (rectangular) shape with no inclined side. Finally, in the DC outlet 1 of 48 V, the plug-receiving portion 15 has the substantially quadrangular (rectangular) shape with inclined sides 15a formed by obliquely cutting the right and left lower corners. The insertion groove 17 also has a shape conforming to the shape of the plug-receiving portion 17.

As described above, the plug-receiving portion 15 has the substantially quadrangular (rectangular) shape viewed from the front in the DC outlet 1 of 24 V, and the plug-receiving portion 15 has the substantially quadrangular (rectangular) shape with the inclined side(s) 15a formed by obliquely cutting at least one of the corners depending on the kinds of the supply voltage in the DC outlets 1 of 6, 12 and 48 V. The shape of the plug-receiving portion 17 has a different outer peripheral shape depending on the kinds of the supply voltage. Accordingly, it is possible to easily discriminate the kinds of the supply voltage by using the outer peripheral shape of the plug-receiving portion 15.

In addition, since the plug-receiving portion 15 has the substantially quadrangular (rectangular) outer peripheral shape with at least one corner that is obliquely cut depending on the kinds of the supply voltage, it is possible to prevent the DC outlets 1 from being scaled up since the shape of the plug-receiving portion 15 does not extend from the rectangular shape.

Besides, since the plug-receiving portion 15 has the different outer peripheral shape depending on the kinds of the supply voltage and the outer peripheral shape of the surrounding wall 23 of the plug 2 is changed conforming to the shape of the plug-receiving portion 15, it is possible to prevent the plug 2 requiring a specific supply voltage from being wrongly connected to the DC outlet supplying a different voltage than the required specific supply voltage and easily recognize the orientation of the plug 2 to be connected to the corresponding DC outlet 1. Accordingly, it is possible to more easily insert the plug 2 into the corresponding DC outlet 1.

In the plug-receiving portion 15 of the present embodiment, the corner or corners thereof on the opposite side (lower side) to the upper side to which the pin-inserting holes 16 are arranged offset closer is or are obliquely cut depending on the kinds of the supply voltage. Accordingly, it is possible to obtain a longer distance between the side with the cut corner or corners and the pin-inserting holes 16 as compared with a case that the corner of the upper side to which the pin-inserting holes 16 are arranged offset closer is obliquely cut depending on the kinds of the supply voltage. Therefore, it is possible to suppress the strength of the plug-receiving portion 15 from being reduced.

In the present embodiment, the shape of the plug-receiving portion 15 is changed by cutting the corner(s) of the lower side of the plug-receiving portion 15 depending on the kinds of the supply voltage. However, the position and the number of the cut corner are not limited to those in the present embodiment. The corner(s) of the reference side KL (upper side) to which the pin-inserting holes 16 are arranged offset closer may be cut or the corner(s) of both the upper side and the lower side may be cut. The shape of the cut section is also not limited to the present embodiment. As shown in FIG. 7E, an angular recess 15h may be formed by angularly cutting the corner of the plug-receiving portion 15.

### Third Embodiment

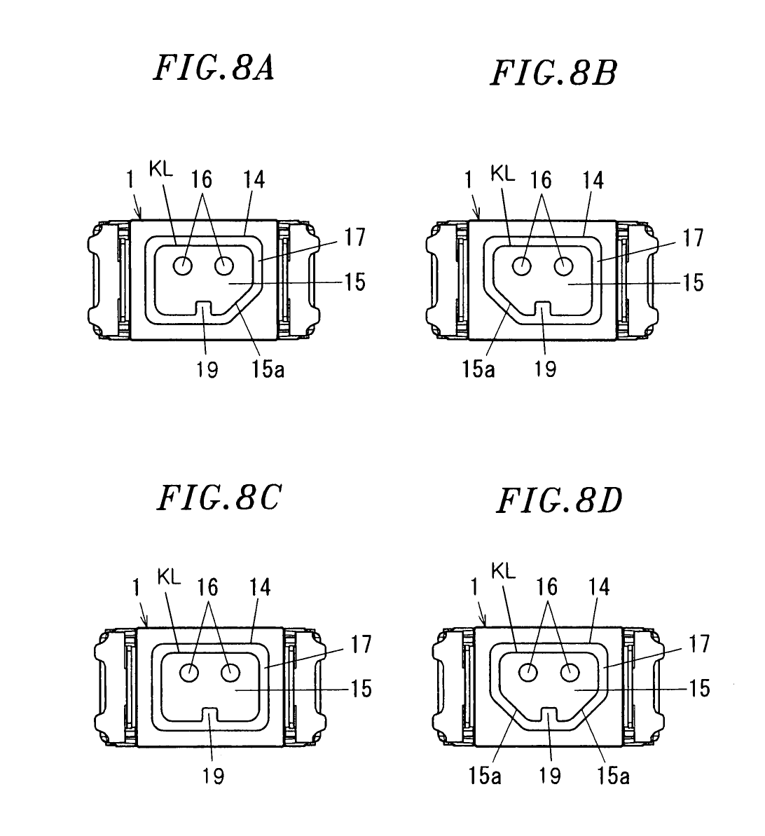

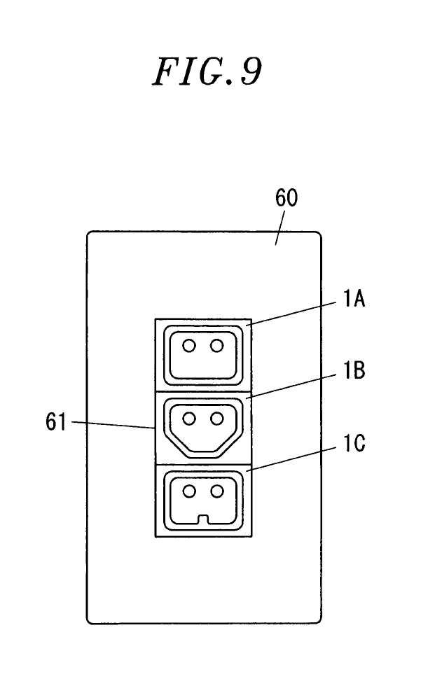

A third embodiment of the present invention will be described with reference to FIGS. 8 and 9. In the DC outlet 1 of the first and the second embodiment, the shape of the portion thereof engaged with the plug 2 is not changed depending on kinds of the power supply circuit serving as the power supply source. However, in the present embodiment, an identifying extension groove 17d (hereinafter, referred to as “extending grove 17d” simply) for identifying the kinds of the power supply circuit is formed by locally extending the insertion groove 17. Since the configuration of the third embodiment is substantially identical to that of the first or the second embodiment except for the extension groove 17d, the components having substantially the same configuration and function are denoted by like reference characters and redundant description thereof will be omitted herein.

As the kinds of the power supply circuit serving as the power supply source, a safety extra low voltage (SELV), an extra low voltage (ELV), a functional extra low voltage (FELV) circuit and the like are standardized by the IEC standard. As shown in FIGS. 8A to 8D, in the DC outlet 1 of the SELV circuit, the extension groove 19 is formed at a central portion of the lower side of the plug-receiving portion 15 in the right-left direction of the lower side. FIGS. 8A, 8B, 8C and 8D show the DC outlet 1 of 6, 12, 24 and 48 V, respectively. As in the second embodiment, the plug-receiving portion 15 has the substantially quadrangular shape with at least one of the corners cut depending on the kinds of the supply voltage, viewed from the front. In the DC power distribution system shown in FIG. 10, the power supply circuit for supplying a DC power to the DC outlet 1 is provided between the AC power supply source AC and the DC outlet 1, e.g., inside the power distributor 70.

Since the extension groove 19 is formed by locally extending the insertion groove 17, it is easer to maintain the strength of the cover 12 as compared with the case that a groove formed separately from the insertion groove 17. It also becomes easer to manufacture the extension groove 19 due to its simple shape. Further, since the extension groove 19 is formed at the side opposite to the side (upper side) to which the pin-inserting holes 16 are arranged offset in the plug-receiving portion 15, it is possible to obtain a sufficient distance between the extension groove 19 and the pin-inserting holes 16 while suppressing the strength of the plug-receiving portion 15 from being reduced.

In addition, since the extension groove 19 is formed by locally extending the insertion groove 17 into the plug-receiving portion 15, it is possible to make the size of a front surface of the boss 12a smaller as compared with a case of extending the insertion groove 17 to a side opposite to the plug-receiving portion 15, thereby preventing the DC outlet from being scaled up. The position, shape and number of the extension groove 19 are not limited to those in the present embodiment. If the kinds of the power supply circuit can be identified by using the extension groove 19, the position, shape and number of the extension groove 19 may be varied.

In the meantime, in the DC outlet 1 of the ELV circuit, no extension groove 19 is formed as shown in FIGS. 7A to 7D. Accordingly, it is possible to easily discriminate the kinds of the power supply circuit depending on whether or not there is the extension groove 19.

In the plug 2 of the SELV circuit, an identifying rib (not shown) for being engaged with the identifying extension groove 19 is formed on the inner surface of the surrounding wall 23. No identifying rib, however, is formed in the plug 2 of the ELV circuit. For that reason, the plug 2 of the ELV circuit may be connected to both the DC outlets 1 of the ELV and the SELV circuit. On the other hand, the plug 2 of the SELV circuit is connected to only the DC outlet 1 of the SELV circuit.

Meanwhile, since the SELV circuit has a higher insulation level than that of the ELV circuit, a load device used in the SELV circuit (hereinafter, referred to as “SELV device”) may not require an insulation performance that is as high as that of a load device used in the ELV circuit (hereinafter, referred to as “ELV device”) and the SELV device may often have a lower insulation performance than that of the ELV device. Accordingly, if the SELV device has the lower insulation performance than that of the ELV device is used in the ELV circuit having a lower insulation level than that of the SELV circuit, the SELV device may be damaged by an electric leakage.

In the present embodiment, since the plug 2 of the SELV circuit is unable to be connected to the DC outlet 1 of the ELV circuit while being able to be connected to the DC outlet 1 of the SELV circuit only, it may be impossible that the SELV device is used in the ELV circuit. Meanwhile, the ELV device may be connected to the DC outlet 1 of the SELV circuit. However, the ELV device has a higher insulation performance than that of the SELV device and the SELV circuit has the higher insulation level that that of the ELV circuit. Accordingly, if the ELV device is used in the SELV circuit, the ELV device may not be damaged.

FIG. 9 shows a construction state of the DC outlet 1. In FIG. 9, two DC outlets 1A and 1B of 24 and 48 V having the ELV circuit; and one DC outlet 1C of 24 V having the SELV circuit are installed together in the mounting frame 50.

### Fourth Embodiment

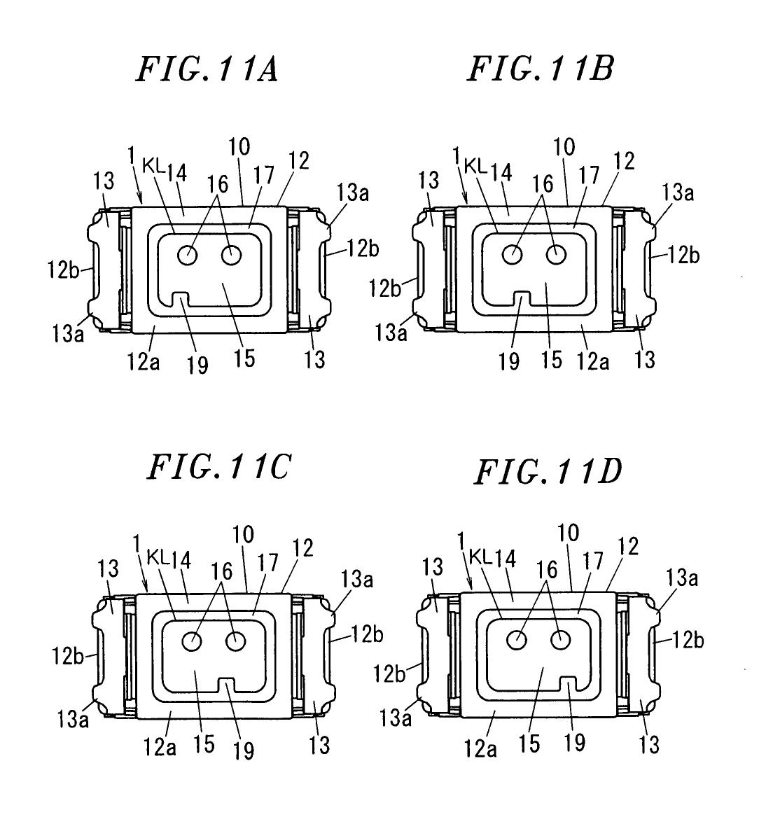

A fourth embodiment of the present invention will be described with reference to FIGS. 11A to 12. In the DC outlet 1 of the second embodiment, the plug-receiving portion 15 has the substantially quadrangular shape with at least one of the corners cut depending on the kinds of the supply voltage, viewed from the front; and the insertion groove 17 is formed around the periphery of the plug-receiving portion 15, so that the shape of the insertion groove 17 is changed depending on the kinds of the supply voltage. In the present embodiment, the extension groove 19 is formed by extending the insertion groove 17 into the plug-receiving portion 15, so that the shape of the plug-receiving portion 15 and the shape of the insertion groove (including the extension groove 19), as viewed from the front, are partially changed depending on the kinds of the supply voltage. Since the structure of the fourth embodiment is substantially identical to that of the first embodiment except for forming the extension groove 19, the components having substantially the same configuration and function are denoted by like reference characters and redundant description thereof will be omitted herein.

FIGS. 11A to 11D are front views showing the DC outlet 1 corresponding to four supply voltages, i.e., 6, 12, 24 and 48 V, respectively. In the plug-receiving portion 15, two pin-inserting holes 16 are arranged offset closer to the upper side serving as the reference side KL of the plug-receiving portion 15. In the DC outlet 1 of 6 V, the extension groove 19 is formed near the left end of the lower side of the plug-receiving portion 15 as shown in FIG. 11A. In the DC outlet 1 of 12 V, the extension groove 19 is formed at a slightly left position with regard to the center of the lower side of the plug-receiving portion 15 as shown in FIG. 11B. In the DC outlet 1 of 24 V, the extension groove 19 is formed at a slightly right position with regard to the center of the lower side of the plug-receiving portion 15 as shown in FIG. 11C. Finally, in the DC outlet 1 of 48 V, the extension groove 19 is formed near the right end of the lower side of the plug-receiving portion 15 as shown in FIG. 11D.

Meanwhile, in the plug 2 to be connected to the DC output 1, as shown in FIG. 12, a rib 23a for being engaged with the extension groove 19 is protruded from a bottom surface of the surrounding wall 23. Accordingly, the plug 2 requiring a voltage is prevented from being wrongly connected to the DC outlet supplying a different supply voltage than the required voltage by the rib 23a engaged with only the corresponding extension groove 19.

As described above, in the present embodiment, by forming the extension groove 19 extending from the insertion groove 17 to the plug-receiving portion 15 at different portions of the lower side of the plug-receiving portion 15 depending on the kinds of the supply voltage so that the shape of the insertion groove 17 viewed from the front is partially changed. Accordingly, it becomes easy to maintain the strength of the plug-receiving portion 15 as compared with the case that an extension groove is formed separately from the insertion groove 17. It also becomes easer to manufacture the plug-receiving portion 15 due to its simple shape.

In addition, the extension groove 19 is formed by locally extending the insertion groove 17 into the plug-receiving portion 15, the shape of the insertion groove 17 is changed such that the area of the plug-receiving portion 15 becomes smaller as compared with the case that the plug-receiving portion 15 has the substantially quadrangular shape viewed from the front. Accordingly, it is possible to prevent the outlet main body 10 from being scaled up since the substantially quadrangular shape of the plug-receiving portion 15 does not extend from the rectangular shape.

Besides, the extension groove 19 is formed at a position close to the side (lower side) opposite to the reference side (upper side) KL of the plug-receiving portion 15 to which the pin-inserting holes are arranged offset. Accordingly, it is possible to obtain a sufficient distance between the insertion groove 17 (including the extension groove 19) and the pin-inserting holes 16 and suppress the strength of the plug-receiving portion 15 from being reduced.

### Fifth Embodiment

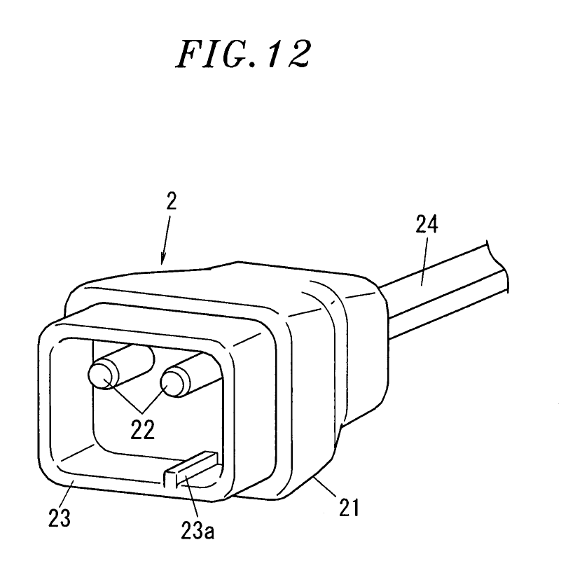

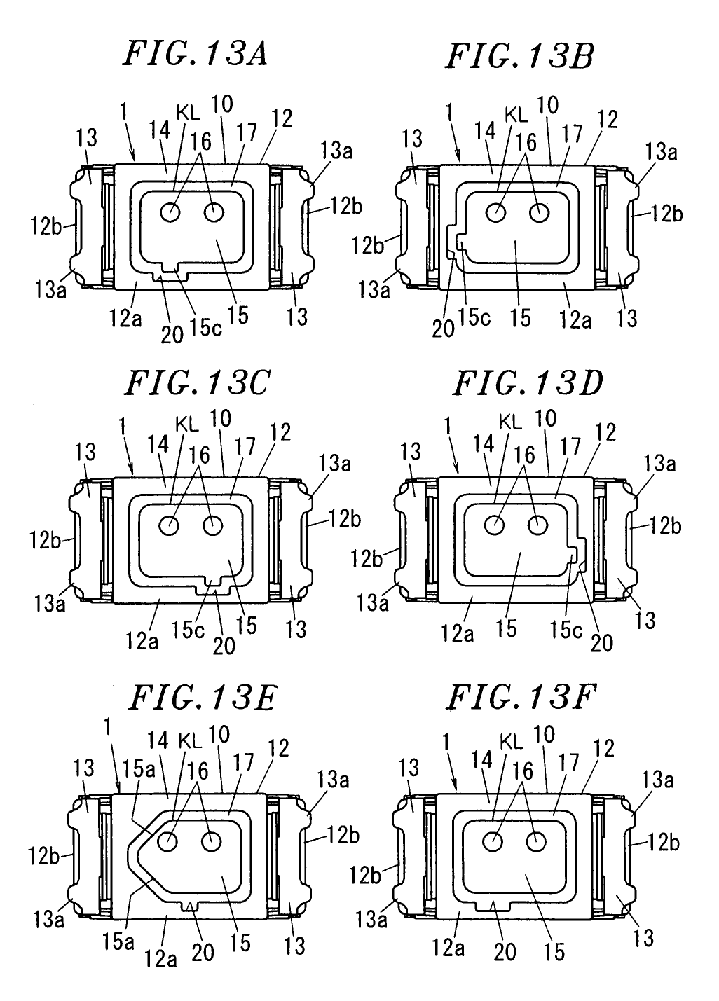

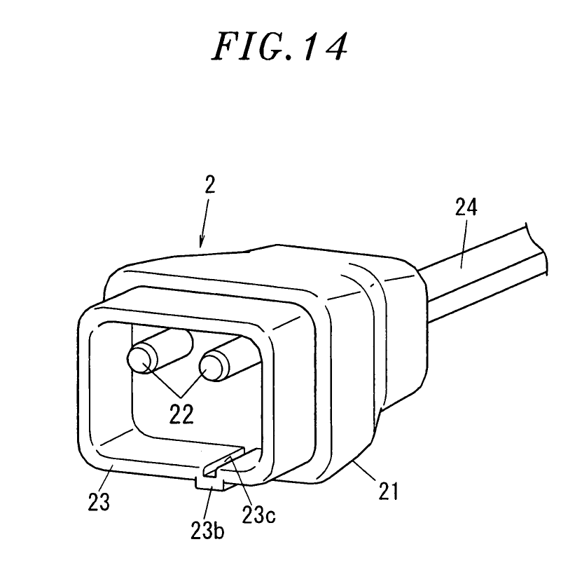

A fifth embodiment of the present invention will be described with reference to FIGS. 13A and 14. In the DC outlet 1 of the fourth embodiment, the extension groove 19 is formed by locally extending the insertion groove 17 into the plug-receiving portion 15, so as to partially change the shape of the insertion groove 17 (including the extension groove 19) viewed from the front depending on the kinds of the supply voltage.

In the present embodiment, an extension groove 20 is formed on a front surface of the outlet main body 10 (i.e., the boss 12a) by locally extending the insertion groove 17 outwardly, so as to partially change the shapes of the plug-receiving portion 15 and the insertion groove 17 (including the extension groove 20, viewed from the front. Since the configuration of the fourth embodiment is substantially identical to that of the first embodiment except for forming the extension groove 20, the components having substantially the same configuration and function are denoted by like reference characters and redundant description thereof will be omitted herein.

FIGS. 13A to 13D are front views showing the DC outlet 1 corresponding to four supply voltages, i.e., 6, 12, 24 and 48 V, respectively. In the plug-receiving portion 15, two pin-inserting holes 16 are arranged offset closer to the upper side serving as the reference side KL. In the DC outlet 1 of 6 V, as shown in FIG. 13A, the extension groove is extended from a left end portion of a lower outer periphery of the insertion groove 17 outwardly (downwardly in FIG. 13A) and a protrusion 15c is protruded from a lower periphery of the plug-receiving portion 15 into the extension groove 20, so that the shape of the insertion groove 17 is partially changed. In addition, in the DC outlet 1 of 12 V, as shown in FIG. 13B, the extension groove is extended from a lower side portion of a left outer periphery of the insertion groove 17 outwardly (to the left in FIG. 13B) and a protrusion 15c is protruded from a left periphery of the plug-receiving portion 15 into the extension groove 20, so that the shape of the insertion groove 17 is partially changed.

In the DC outlet 1 of 24 V, as shown in FIG. 13C, the extension groove 20 is extended from a right end portion of the lower outer periphery of the insertion groove 17 outwardly (downwardly in FIG. 13C) and a protrusion 15c is protruded from the lower periphery of the plug-receiving portion 15 into the extension groove 20, so that the shape of the insertion groove 17 is partially changed. In addition, in the DC outlet 1 of 48 V, as shown in FIG. 13D, the extension groove 20 is extended from a lower side portion of the right outer periphery of the insertion groove 17 outwardly (to the right in FIG. 13D) and a protrusion 15c is protruded from the right periphery of the plug-receiving portion 15 into the extension groove 20, so that the shape of the insertion groove 17 is partially changed.

Moreover, as shown in FIG. 3F, without providing the protrusion 15c while keeping the plug-receiving portion 15 in the substantially quadrangular (rectangular) shape viewed from the front, only the extension groove 20 may be formed so as to partially change the shape of the insertion groove 17.

Meanwhile, in the plug 2 to be connected to the DC outlet 1, as shown in FIG. 14, a rib 23b for being engaged with the extension groove 20 is protruded from the outer surface of the surrounding wall 23; and an engaging groove 23c for being engaged with the protrusion 15c is formed in an inner surface of the surrounding wall 23. Accordingly, the plug 2 requiring a supply voltage is prevented from being wrongly connected to the DC outlet supplying a different supply voltage than the required supply voltage by the rib 23b and the protrusion 15c engaged with only the corresponding extension groove 20 and the corresponding engaging groove 23c, respectively.

As described above, in the present embodiment, the extension groove 20 is formed on the front surface of the outlet main body 10 (i.e., the boss 12a) by locally extending the insertion groove 17 outwardly, to thereby partially change the shapes of the plug-receiving portion 15 and the insertion groove 17 depending on the kinds of the supply voltage. Further, the shape of the insertion groove 17 is changed depending on the kinds of the supply voltage such that the area of the plug-receiving portion 15 becomes larger as compared with the case that the plug-receiving portion 15 has the substantially quadrangular shape viewed from the front. Accordingly, it is possible to satisfactorily maintain the strength of the plug-receiving portion 15 without causing the area of the plug-receiving portion 15 to become smaller than that of the substantially quadrangular shape of the plug-receiving portion 15 even when the shape of the insertion groove 17 is changed.

The position, shape and number of the protrusion 15c of the plug-receiving portion 15 and those of the extension groove 20 of the insertion groove 17 are not limited to the present embodiment. If the kinds of the supply voltage can be identified by the plug-receiving portion 15 and/or the insertion groove 17, it may be possible to change at least one of the shapes of the plug-receiving portion 15 and the insertion groove 17 depending on the kinds of the supply voltage regardless of the position, shape and number of the changed portion.

### Sixth Embodiment

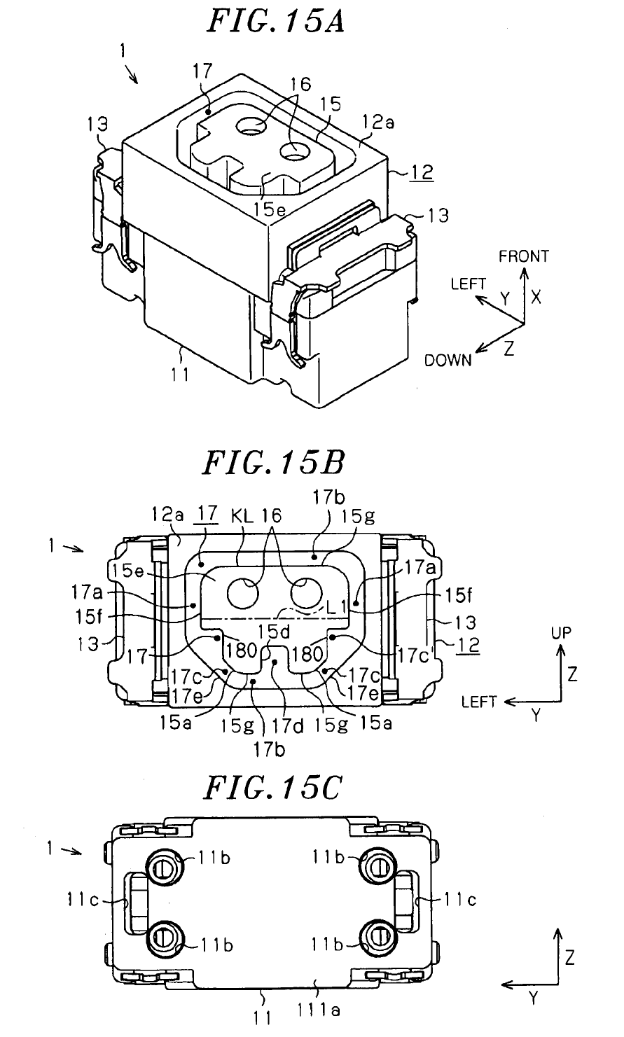

Hereinafter, the DC outlet 1 in accordance with a sixth embodiment of the present invention will be described with reference to FIGS. 15A to 20D.

In the present embodiment, the shapes of the plug-receiving portion 15 and the insertion groove 17, viewed from the front, are partially changed depending on kinds of the supply current. Since the configuration of the sixth embodiment is substantially identical to that of the first embodiment, the components having substantially the same configuration and function are denoted by like reference characters and redundant description thereof will be omitted herein.

Referring to FIGS. 15A to 17D, the insertion groove 17 includes a pair of first grooves 17a extending in the up-down direction Z; a pair of second grooves 17b extending in the left-right direction Y; and inclined grooves 17c for respectively connecting the first grooves 17a to the lower second groove 17b. The inclined grooves 17c are provided below the central line L1 (indicating half portion of a length of the up-down direction Z) of the plug-receiving portion 15. Further, the insertion groove 17 includes first extension grooves 17d continuously upwardly extending from the lower second groove 17b, the first extension grooves 17d being provided at a central portion of the left-right direction Y of the lower second groove 17b.

The plug-receiving portion 15 includes first sides 15f respectively corresponding to the first grooves 18a; second sides 15g respectively corresponding to the second grooves 17b; inclined sides 15a respectively corresponding to the inclined grooves 17c; and recessed portions respectively corresponding to the first extension grooves 17d. The inclined sides 15a respectively constitute parts of the inclined grooves 17c and are respectively provided in parallel with facing sides 17e facing the inclined sides 15a.

Above the central line L1 of the plug-receiving portion 15, the two of pin-inserting holes 16 are provided to extend through the plug-receiving portion 15 in the front-rear direction X. In other words, the upper second side 15g serves as the reference side KL, and the pin-inserting holes 16 are arranged offset closer to the reference side KL than the lower second side 15g.

As shown in FIG. 15C, at a bottom wall 111a of the body 11, four line-through holes 11b through which electrical lines are inserted; and two manipulation holes 11c. The line-through holes 11b and the manipulation holes 11c serve as through holes extending through the bottom wall 11a in the front-rear direction X. The manipulation holes 11c are used to separate the DC supply lines Wdc from the DC outlet 1.

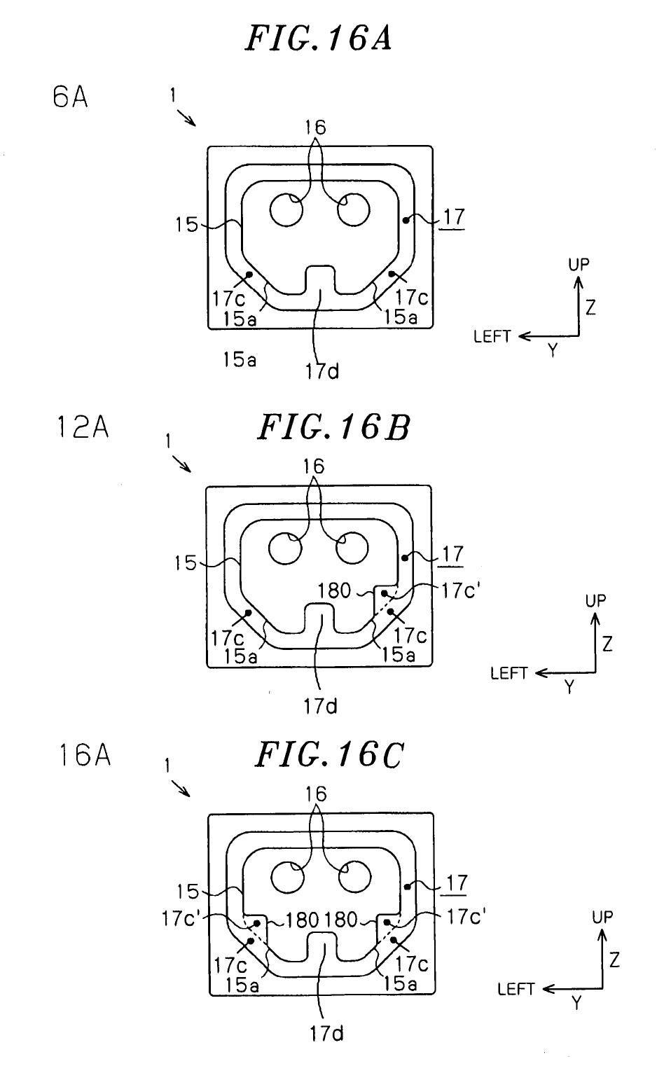

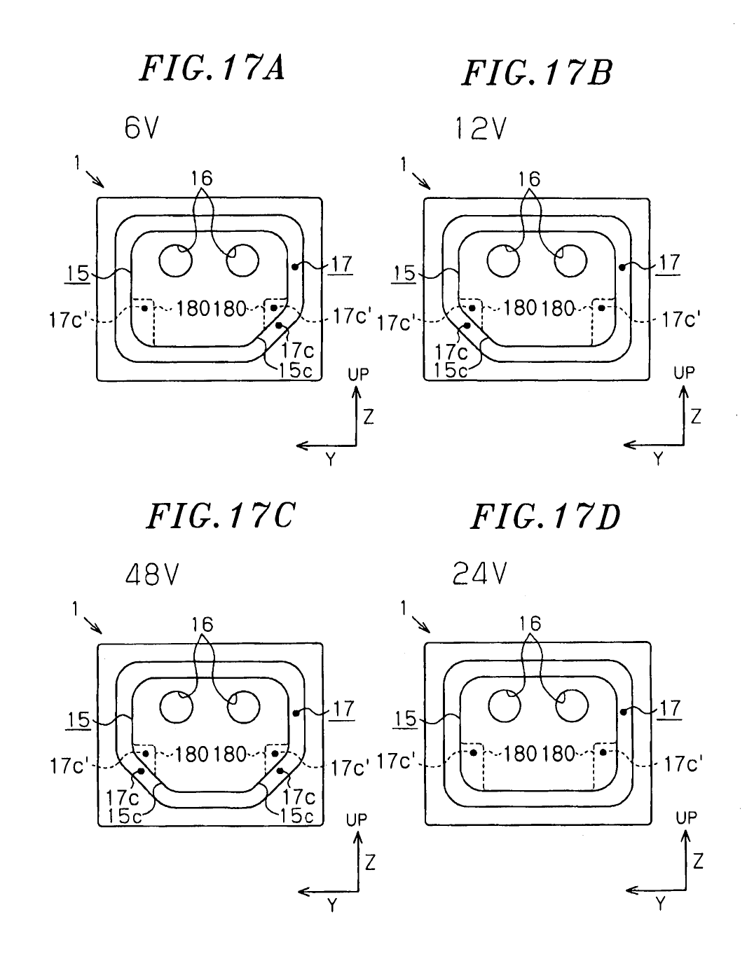

The shapes of the plug-receiving portion 15 and the insertion groove 17 changed depending on the supply current and the supply voltage will be described with reference to FIGS. 16A to 17D. In FIGS. 16A to 16C, the DC outlets 1 for the supply voltage of 48 V and the SELV circuit are used as an example.

There is a plurality of electric devices requiring supply currents, e.g., 6, 12, and 16 A. In the present embodiment, the shape of the insertion groove 17 is changed by forming an indentation in the shape of the plug-receiving portion 15 viewed from the front, to thereby make the DC outlets 1 distinguishable depending on the kinds of the supply current. In other words, based on the DC outlet 1 of the supply current of 6 A as shown in FIG. 16A, the indentation or indentations are provided in the DC outlets 1 of the supply voltages of 12 and 16 A.

Specifically, in the DC outlet 1 of the supply current of 12 A as shown in FIG. 16B, a triangularly shaped second extension groove 17c′ is provided at an upper portion of the inclined groove 17c by internally extending from the inclined groove 17c in the left-right direction Y. Similarly, an indentation 180 constituting two sides of the triangularly shaped second extension groove 17c′ is provided at a portion of the plug-receiving portion 15 corresponding to the second extension groove 17c′. Moreover, in the DC outlet 1 of the supply current of 16A as shown in FIG. 16C, the second extension groove 17c′ and the indentation 180 are provided at the upper portion of each of the two insertion grooves 17c. Meanwhile, in case that the inclined groove 17c is not provided in the insertion groove 17, each of the second extension groove 17c′ and the indentation 180 may be formed to have a substantially quadrangular shape viewed from the front.

FIGS. 16A to 16C shows the DC outlets 1 in the case of the supply voltage of 48 V, and FIGS. 17A to 17D show the DC outlets in the case of the supply current of 6 A. Alternatively, the shapes of the insertion groove 17 and the plug-receiving portion 15 for identifying the supply current and the supply voltage may be mixed. Specifically, as shown by dotted lines in FIGS. 17A to 17D, the second extension groove 17c′ and the indentation 180 may be respectively provided at the lower left and/or right corner of the insertion groove 17 and the plug-receiving portion 15. Accordingly, it is possible to manufacture the DC outlets 1 capable of identifying a plurality of supply voltage and currents, e.g., the DC outlets of 6 V and 6 A, 6 V and 12 A, and 6 V and 16 A in the case of the supply voltage of, e.g., 6 V.

In addition to such identification of the supply voltages and currents, it is also possible to identify together whether the DC outlet 1 corresponds to the SELV or the ELV circuit. Specifically, the first extension groove 17d may be provided in the DC outlet 1 of the SELV circuit as shown in FIGS. 16A to 16C, and the first extension groove 17d is not provided in the DC outlet 1 of the ELV circuit as shown in FIGS. 17A to 17D. Accordingly, it is possible to manufacture two kinds of the DC outlets 1, i.e., the DC outlet 1 of 6 V and 6 A having the ELV circuit; and the DC outlet 1 of 6 V and 6 A having the SELV circuit in the case of the supply voltage of 6 V and the supply current of 6 A, for example.

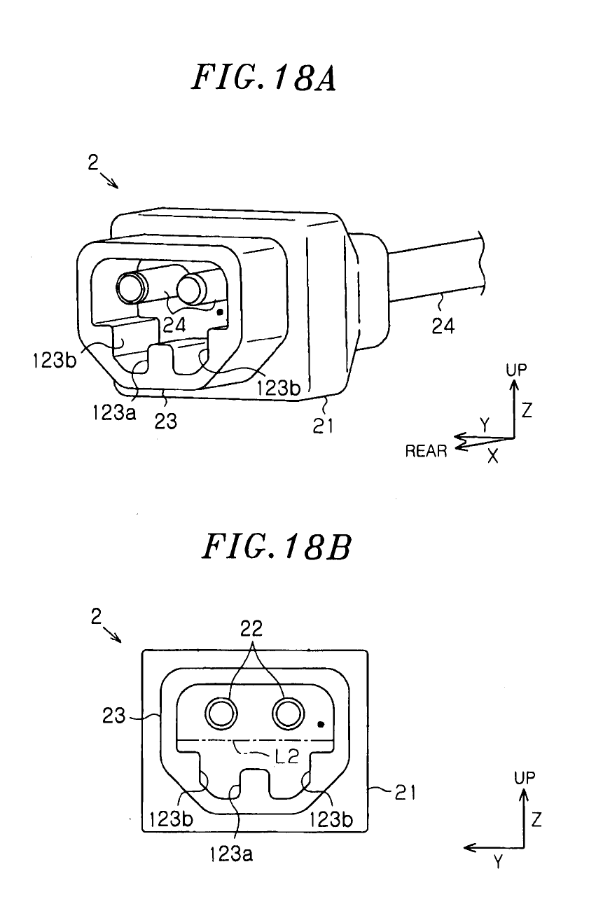

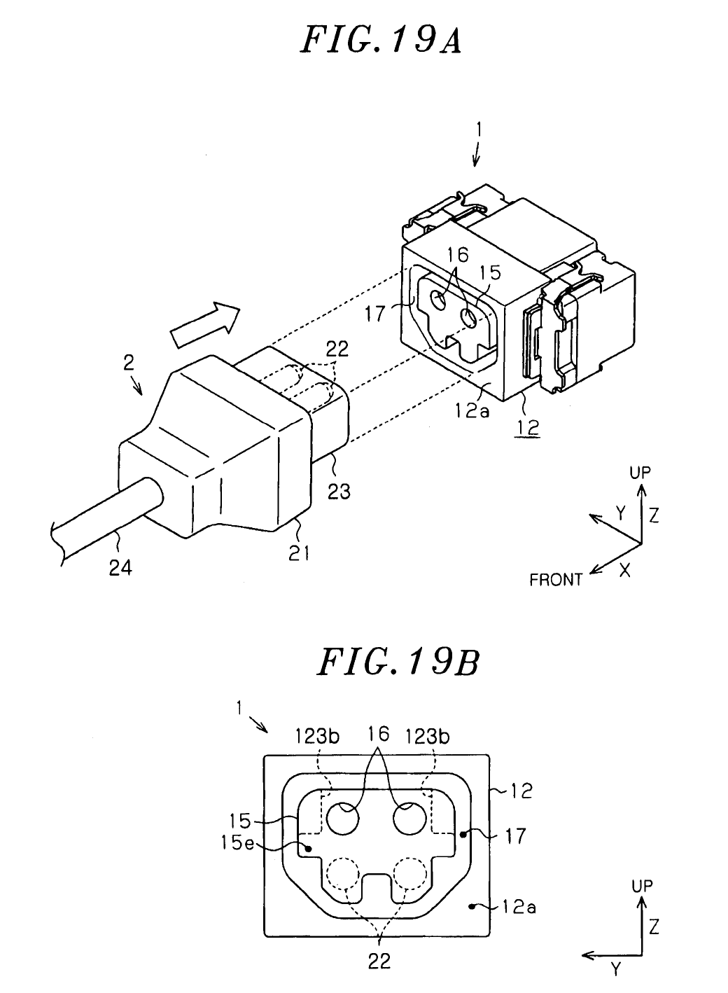

Next, a structure of the plug 2 will be described with reference to FIGS. 18A to 19B.

As shown in FIGS. 18A and 18B, the surrounding wall 23 of the plug 2 has a shape that is substantially identical to that of the insertion groove 17 (see FIGS. 19A and 19B). Specifically, the surrounding wall 23 has the shape corresponding to the first groove 17a, the second groove 17b and the inclined groove 17c of the insertion groove 17; and a first rib 123a corresponding to the first extension groove 17d, a second rib 123b corresponding to the second extension groove 17c′ are provided in the surrounding wall 23.

As shown in FIG. 18B, the plug pins 22 are provided above a central line L2 of the up-down direction Z of the surrounding wall 23. The plug pins 22 are arranged along the left-right direction Y, and a positive plug pin (left side in FIG. 18B) and a negative plug pin (right side in FIG. 18B) constitute the plug pins 22.

As shown in FIG. 19A, when the plug 2 is connected to the DC outlet 1, the surrounding wall 23 is first inserted into the insertion groove 17. Then, the plug pins 22 are respectively inserted into the pin-inserting holes 16. A positive pin-inserting hole through which the positive plug pin is inserted and a negative pin-inserting hole through which the negative plug pin is inserted constitute the pin-inserting holes 16.

As shown in FIG. 19B, when the plug 2 is reversely inserted into the DC outlet 1, the plug pins 22 are arranged below the central line L1 (see FIG. 15B) of the plug-receiving portion 15. Accordingly, the plug pins 22 are brought into contact with a front surface 15e of the plug-receiving portion 15, thereby making it impossible to reversely insert the plug 2 into the DC outlet 1.

In other words, when the plug 2 is reversely inserted into the DC outlet 1, the plug pins 22 are positioned separately from the pin-inserting holes 16 in the up-down direction Z. Accordingly, such reverse insertion can be prevented reliably.

Specifically, in this case, the second rib 123b is misaligned with the second extension groove 17c′. In other words, the second rib 23b is brought into contact with the front surface 15e of the surrounding wall, thereby making it impossible to reversely insert the surrounding wall 23 into the insertion groove 17. Accordingly, the reverse insertion of the surrounding wall 23 into the insertion groove 17 can be prevented.

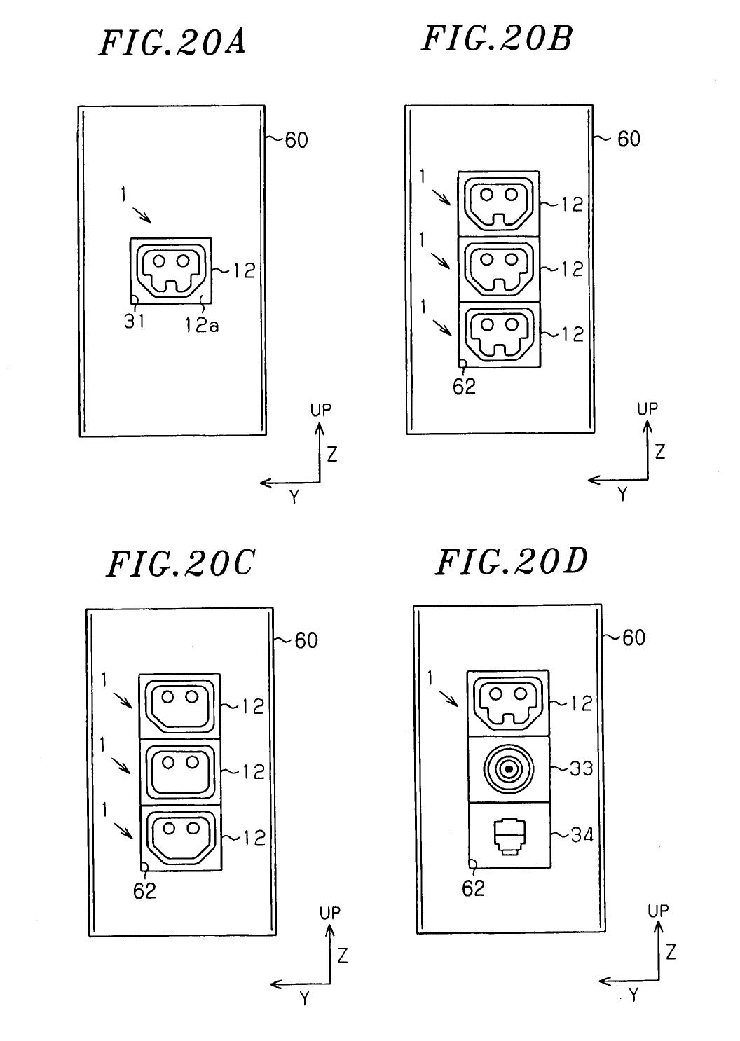

Next, various arrangements of the DC outlet 1 will be described with reference to FIGS. 20A and 20B.

As shown in FIG. 20A, in a state that the DC outlet 1 is mounted in the mounting frame 50, the decoration frame 60 is attached to the mounting frame 50 from the front thereof. The window opening 61 of one module dimension is formed in the decoration plate 60 to expose the front surface of the cover 12.

Since the size of the DC outlet 1 is one module dimension, the DC outlet 1 and other wiring devices of one or two module dimensions standardized by the Japanese Industrial Standard are mounted together in the mounting frame 50. In other words, the DC outlet 1 and the wiring devices are mounted together in the mounting frame 50.

A window opening 62 of three module dimensions is formed in the decoration plate 60. For example, the DC outlets 1 of the supply voltage of 48 V which have different shapes to identify the supply current are provided as shown in FIG. 20B. For another example, the DC outlet 1 of the supply current of 6 A which have different shapes to identify the supply voltage are provided as shown in FIG. 20C. For still another example, the DC outlet 1, a coaxial cable outlet 33 and a phone modular outlet 34 are shown in FIG. 20D. The wiring devices are not limited to the coaxial cable outlet 33 and the phone modular outlet 34. For example, an AC outlet and/or a LAN modular outlet may be used.

The effects of the DC outlet 1 in accordance with the present embodiment will be described as follows.

(1) In the present embodiment, the second extension groove 17c′ is provided in the receiving grove 17 depending on the kinds of the supply current. Accordingly, it is possible to provide the DC outlet 1 having a shape that is changed to identify the kinds of the supply current. Further, since the second extension groove 17c′ is provided in the insertion groove 17, it is possible to obtain a common shape of the plug pins 22 as compared with a case the shape of the pin-inserting hole is changed to identify a supply current.

If the shape of the plug pins 22 is changed, the shape of the pin-receiving pieces 18 is required to be changed to conform to the shape of the plug pins 22. Since, however, the shape of the plug pins 22 is not changed in the present embodiment, it is also possible to obtain a common shape of the pin-receiving pieces 18 regardless of the kinds of the supply voltage. Accordingly, it is possible to discriminate the kinds of supply voltage by changing the shape of the cover 12 only.

(2) In the present embodiment, the second extension groove 17c′ is provided below the central line L1. Accordingly, since it is possible to obtain the larger distance between the second extension groove 17c′ and the pin-inserting grooves 16 as compared with the case that the second extension groove 17c′ is provided above the central line L1, it is possible to improve the strength of the plug-receiving portion 15. Therefore, it is possible to suppress the plug-receiving portion 15 from being damaged when the plug 2 is inserted into and separated from the DC outlet 1.

(3) In the present embodiment, since the second extension groove 17c′ is provided below the central line L1, the second rib 123b of the plug 2 is misaligned with the second extension groove 17c′ when the plug 2 is reversely inserted into the DC outlet 1. In other words, the second rib 123b is brought into contact with the front surface 15e of the plug-receiving portion 15 and, thus, the second rib 23b is suppressed from being reversely inserted in the second extension groove 17c′. Accordingly, the reverse insertion of the surrounding wall 23 into the insertion groove 17 can be prevented.

(4) In the present embodiment, the second extension groove 17c′ is formed by extending the insertion groove 17. Accordingly, it is possible to suppress the cover 12 from being scaled up and the strength of the plug-receiving portion 15 from being deteriorated as compared with the case that the second extension groove 17c′ is formed separately from the insertion groove 17. The same can be applied to the first extension groove 17d.

### Modifications

The DC output 1 of the present embodiment may be modified as follows without being limited to the present embodiments. Further, the modifications may be individually realized or selectively combined.

Although the present invention is applied to the DC outlet 1 in the present embodiment, it may be applied to an AC outlet. Moreover, the pin-inserting holes 16 are arranged above the central line L1 in the present embodiment. The pin-inserting holes may alternatively be arranged below the central line L1 or at the same position as the central line L1.

Although the inclined groove 17c and the inclined side 15a are provided below the central line L1 in the present embodiment, the inclined groove 17c and/or the inclined side 15a may be provided above the central line L1 or at the same position as the central line L1. In case that the inclined groove 17c and the inclined side 15a may be provided above the central line L1, the inclined groove 17c and the inclined side 15a are inclined toward the upper second groove 17b and the upper second side 15g, respectively.

Although the indentation 180 and the second extension groove 17c′ for identifying the kinds of the supply current are provided below the central line L1 in the present embodiment, the indentation 180 and/or the second extension groove 17c′ may be provided above the central line L1 or at the same position as the central line L1. In case that the indentation 180 and the second extension groove 17c′ are provided at the same position as the central line L1, each of the indentation 180 and the second extension groove 17c′ has a substantially quadrangular shape, viewed from the front. In case the indentation 180 and the second extension groove 17c′ are provided above the central line L1, the indentation 180 and the second extension groove 17c′ are extended from the upper second side 15g and the upper second groove 17c, respectively.

Although the second extension groove 17c′ is formed to extend toward the plug-receiving portion 15 in the present embodiment, the second extension groove 17c′ is not limited thereto. Alternatively, the second extension groove 17c′ may be formed to outwardly extend in, e.g., the upper, the lower, or the left and right direction other than the insertion groove 17. The same can be applied to the first extension groove 17d.

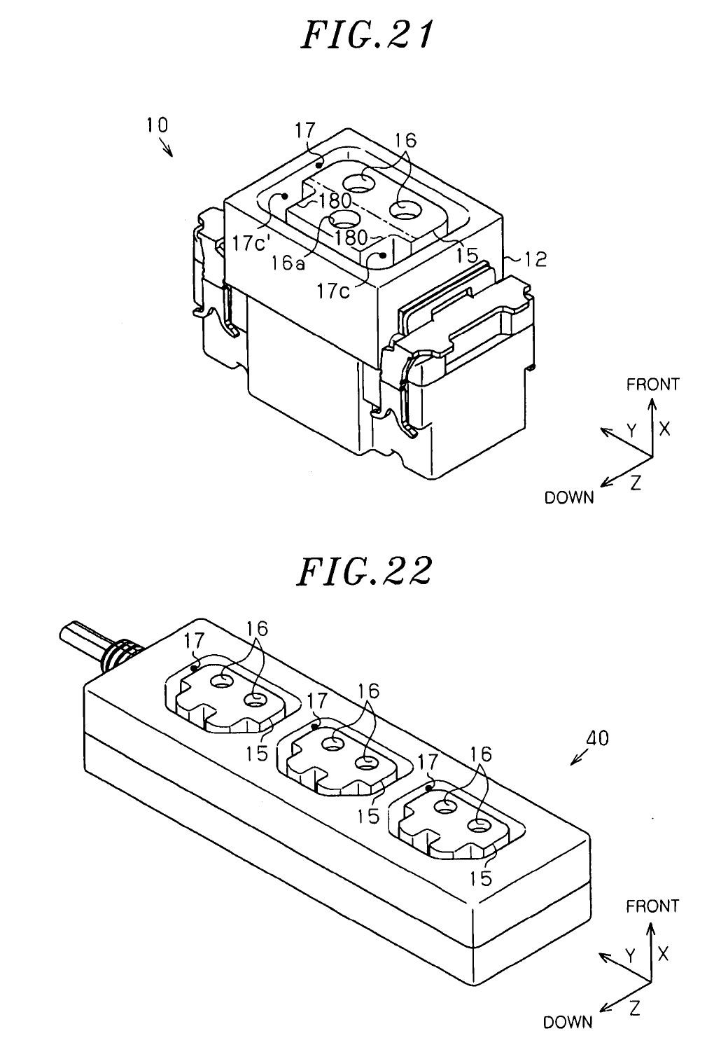

Although only the pin-inserting holes 16 are provided in the plug-receiving portion 15 in the present embodiment, a ground pin inserting hole 16a may be further provided in addition to the pin-inserting holes 16 as shown in FIG. 21. In this case, the ground pin inserting hole 16a is provided at a central portion of the left-right direction Y below the central line L1. In such configuration, three pin-receiving pieces 18 in total are provided to correspond to the two pin-inserting holes 16 and one ground pin inserting hole 16a.

Although each of the insertion groove 17 and the plug-receiving receiving portion 15 has the substantially quadrangular shape with two corners cut, viewed from the front, in the present embodiment, each shape of the insertion groove 17 and the plug-receiving portion 15 is not limited thereto. For example, as shown in FIG. 21, each of the insertion groove 17 and the plug-receiving portion 15 may be formed to have a substantially quadrangular shape without the inclined groove 17c and the inclined side 15a. Further, the shapes viewed from the front of the insertion groove 17 and the plug-receiving portion 15 may be a ring shape and a circular shape, respectively, without being limited to the substantially quadrangular shape. With such configuration, it is possible to obtain a similar effect to the effect (1) of the present embodiment.

Although the DC outlet 1 is buried in a wall in the above embodiments, the DC outlet 1 is not limited to the above embodiments. For example, the DC outlet 1 may be applied to a multi-outlet power strip 40 as shown in FIG. 22. As shown in FIG. 22.

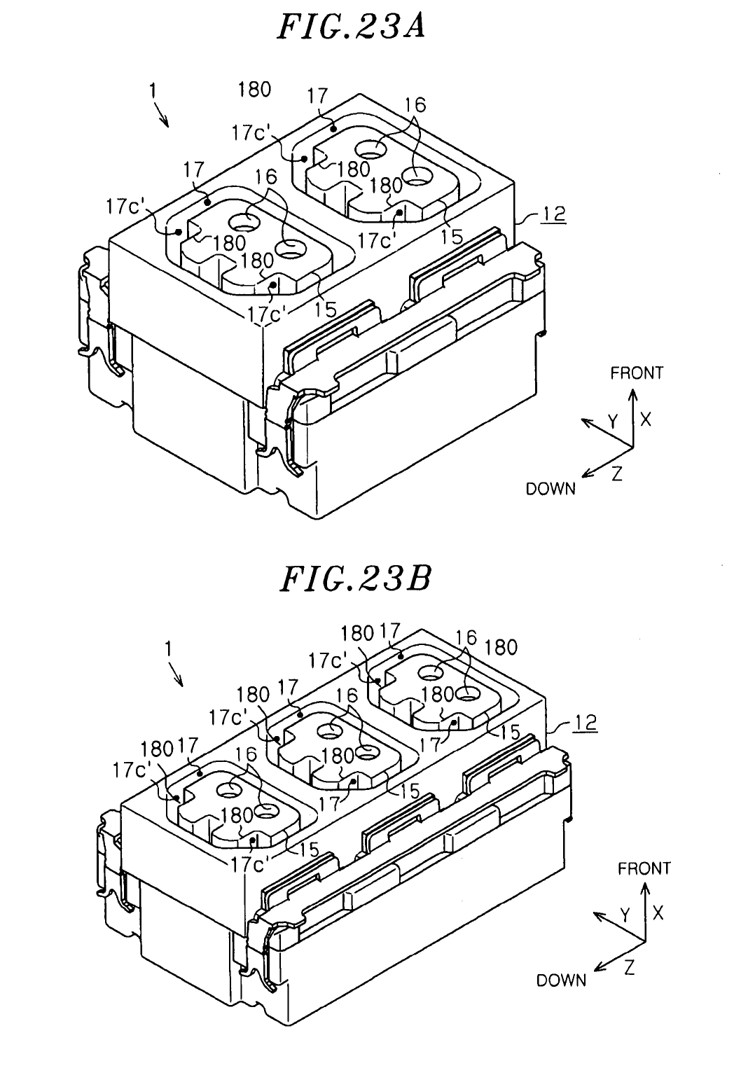

Although the DC outlet 1 is formed to have one module dimension in the above embodiments, the DC outlet 1 may be formed to have two module dimension as shown in FIG. 23A or three module dimension as shown in FIG. 23B.

Although the insertion groove 17 has the rectangular shape having the longer side in the left-right direction Y and the shorter side in the up-down direction Z, viewed from the front, in the above embodiments, the shape of the insertion groove 17 is not limited to the above embodiments. The insertion groove 17 may have a square shape having the same length in the left-right direction Y and the up-down direction Z, viewed from the front.

### Seventh Embodiment

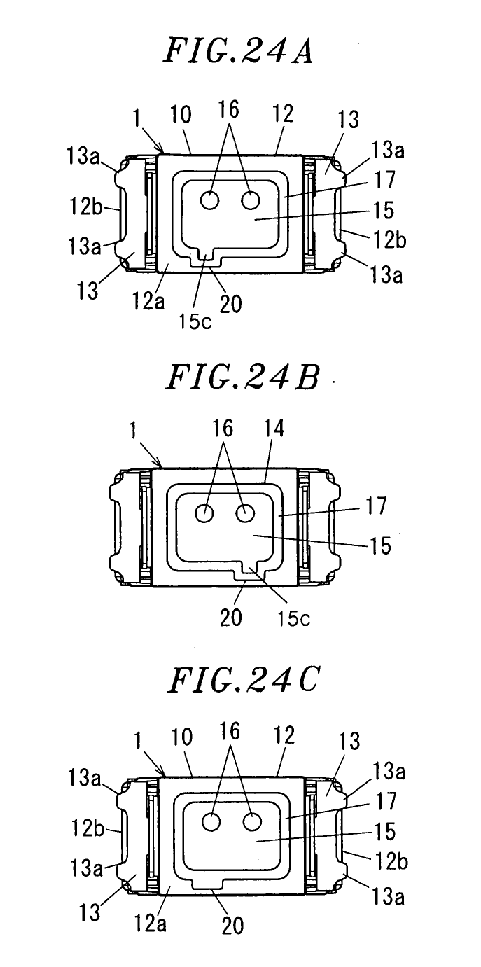

A seventh embodiment of the present invention will be described with reference to FIGS. 24A to 26. In the DC outlet 1 of the third embodiment, the extension groove 19 is formed by extending from the insertion groove 17 toward the plug-receiving portion 15 to differently change the shape of the insertion groove 17 depending on the kinds of the power supply circuit. In the DC outlet 1 of the present embodiment, the extension groove 20 is formed by externally extending from the insertion groove 17 in a front surface of the outlet main body (i.e., the boss 12a); and the protrusion 15c is formed by protruding from a periphery of the plug-receiving portion 15 toward the extension groove 20, so as to change the shape of the insertion groove 17 (including the extension groove 20) differently depending on the kinds of the power supply circuit. Since the structure of the seventh embodiment is substantially identical to that of the third embodiment except for the extension groove 20 and the protrusion 15c, the components having substantially the same configuration and function are denoted by like reference characters and redundant description thereof will be omitted herein.

As the power supply circuit used for the DC outlet 1 of the present embodiment, there are an ELV circuit and an SELV circuit standardized by the IEC standard. The shape of the insertion groove 17 (including the extension groove 20) is changed differently depending on the kinds of the power supply circuit. FIGS. 24A and 24B are front views showing the DC outlet 1 of the SELV circuit and the ELV circuit, respectively.

In the DC outlet 1 of SELV circuit, the extension groove 20 is formed by extending from a lower left portion of the insertion groove 17 toward an outside (e.g., a lower side in FIG. 24A); and the protrusion 15c is formed by protruding toward the extension groove 20 from a left portion of a lower periphery of the plug-receiving portion 15. Moreover, in the DC outlet 1 of ELV circuit, the extension groove 20 is formed by extending from a lower right portion of the insertion groove 17 toward an outside (e.g., a lower side in FIG. 24B); and the protrusion 15c is formed by protruding toward the extension groove 20 from a right portion of the lower periphery of the plug-receiving portion 15.

Alternatively, as shown in FIG. 24C, the shape of the insertion groove 17 may be changed differently depending on the kinds of the power supply circuit by providing the plug-receiving portion 15 having a substantially quadrangular shape viewed from the front and forming the extension groove 20 only.

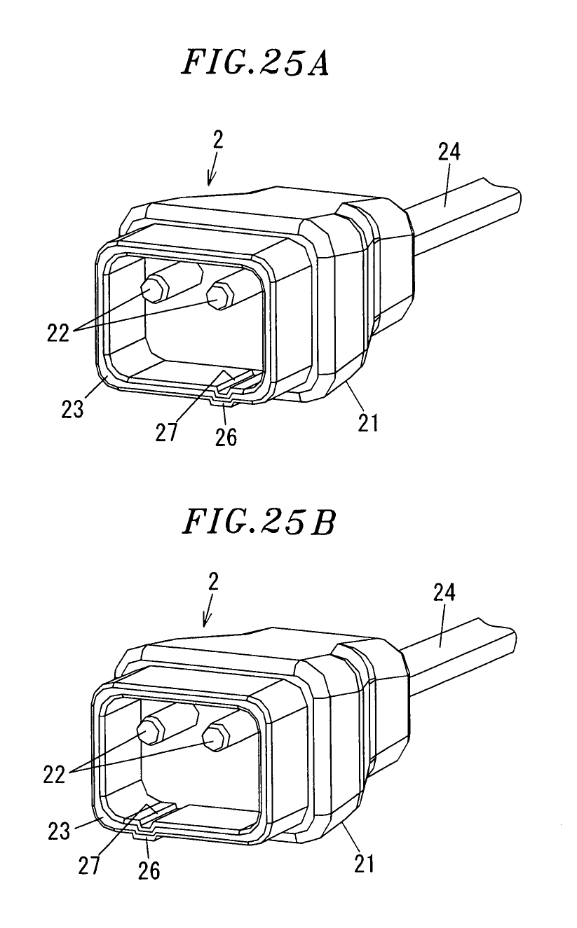

FIGS. 25A and 25B show the plugs 2 of the SELV circuit and the ELV circuit, respectively, to be connected to the DC outlet 1. As shown in FIG. 25A, in the plug 2 of the SELV circuit, a rib 26 to be engaged with the extension groove 20 is protrudently formed at a portion of a peripheral surface (a right portion of an outer surface of a lower wall) of the surrounding wall 23 to correspond to the extension groove 20 provided in the DC outlet 1 of the SELV circuit; and an inserting groove 27 to be engaged with the protrusion 15c is protrudently formed at a portion of an inner peripheral surface (a right portion of an inner surface of the lower wall) of the surrounding wall 23 to correspond to the protrusion 15c provided in the DC outlet 1 of the SELV circuit.

Moreover, as shown in FIG. 25B, in the plug 2 of the ELV circuit, the rib 26 to be engaged with the extension groove 20 is protrudently formed at a portion of a peripheral surface (a left portion of an outer surface of a lower wall) of the surrounding wall 23 to correspond to the extension groove 20 provided in the DC outlet 1 of the ELV circuit; and the inserting groove 27 to be engaged with the protrusion 15c is protrudently formed at a portion of an inner peripheral surface (a left portion of an inner surface of the lower wall) of the surrounding wall 23 to correspond to the protrusion 15c provided in the DC outlet 1 of the ELV circuit.

In this way, the shape of the insertion groove 17 including the extension groove 20 is partially changed depending on the kinds (the SELV or the ELV circuit) of the power supply circuit. Accordingly, it is possible to easily discriminate the kinds of the power supply circuit from the difference of the shapes of the insertion groove 17 viewed from the front.

Further, as described above, positions of the extension groove 20 and the protrusion 15c in the DC outlet of the SELV are different from those of the extension groove 20 and the protrusion 15c in the DC outlet 1 of the ELV circuits; and the rib 26 and the inserting groove 27 to be respectively engaged with the extension groove 20 and the protrusion 15c in each of the plugs 2 of the SELV circuit and the ELV circuit.

Accordingly, the plugs 2 of the SELV circuit and the ELV circuit are respectively connected to the DC outlets of the SELV circuit and the ELV circuit without reverse connection. For that reason, it is possible to safely use an SELV device without a case that the SELV device requiring a lower insulation performance than that of an ELV device is used in the ELV circuit having a lower insulation level than that of the SELV circuit.

Further, since the extension groove 20 is formed by externally extending from the insertion groove 17 to change the shape of the insertion groove 17 differently depending on the kinds of the power supply circuit in the present embodiment, it is possible to maintain the strength of the plug-receiving portion 15 without reduction of the area of the front surface of the plug-receiving portion 15.

In the present embodiment, the shape of the insertion groove 17 viewed from the front is changed differently depending on the kinds of the power supply circuit such that the area of the plug-receiving portion 15 is increased as compared with the plug-receiving portion 15 has the substantially quadrangular shape viewed from the front thereof. Accordingly, it is possible to suppress the strength of the plug-receiving portion 15 from being deteriorated as compared with a case that the shape of the groove 17 is changed such that the area of the plug-receiving portion 15 is decreased.

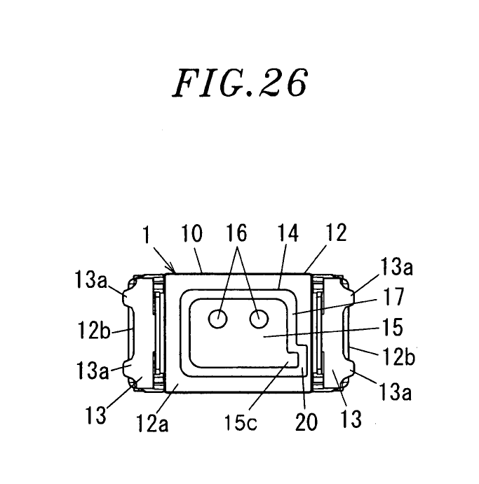

In the present embodiment, the extension groove 20 is formed by extending from the lower portion of the insertion groove 17 toward the outside (the lower side in FIGS. 24A to 24C). However, the position, the shape and the number of the extension groove 20 are not limited to the present embodiment. For example, as shown in FIG. 26, the extension groove 20 may be formed by extending from a right portion of the insertion groove 17 toward to an outside (a right side in FIG. 26) and the protrusion 15c may be formed by protruding from a right periphery of the plug-receiving portion 15 toward the extension groove 20.

In the present embodiment, the extending groove 20 and the protrusion 15c are formed in both the DC outlets 1 of the SELV and ELV circuit. However, the extending groove 20 and the protrusion 15c may be formed in the DC outlet 1 of the SELV circuit only, and the insertion groove 17 having a substantially quadrangular ring shape viewed from the front thereof may be provided in the DC outlet 1 of the ELV circuit.

### Eighth Embodiment

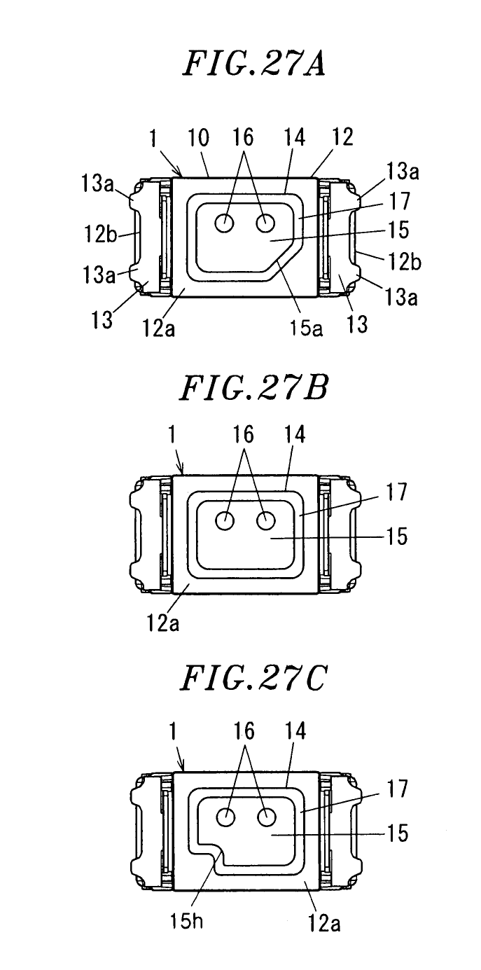

The DC outlet 1 of an eighth embodiment will be described with reference to FIGS. 27A to 29. In the first and the second embodiment, the extension grooves 19 and 20 are formed by extending from the extension groove 17 so as to partially change the shape of the insertion groove 17. In the present embodiment, the shape of the insertion groove 17 viewed from the front is changed differently depending on the kinds of the power supply circuit such that the area of the plug-receiving portion 15 is decreased as compared with the plug-receiving portion 15 has a substantially quadrangular shape viewed from the front. Since the configuration of the seventh embodiment is substantially identical to that of the seventh embodiment except for the shape of the insertion groove 17, the components having substantially the same configuration and function are denoted by like reference characters and redundant description thereof will be omitted herein.

FIGS. 27A and 27B are front views showing the DC outlet 1 of the SELV circuit and the ELV circuit, respectively. In the DC outlet 1 of the ELV circuit, as shown in FIG. 27B, the plug-receiving portion 15 has the substantially quadrangular (rectangular) shape viewed from the front; and an outer peripheral shape of the insertion groove 17 is similar to an inner peripheral shape thereof (an outer peripheral shape of the plug-receiving portion 15). Moreover, in the DC outlet 1 of the SELV circuit, as shown in FIG. 27A, the inclined side 15a is formed by obliquely cutting a lower right corner of the insertion groove 17 (the plug-receiving portion 15); and the outer peripheral shape of the insertion groove 17 is similar to the inner peripheral shape thereof.

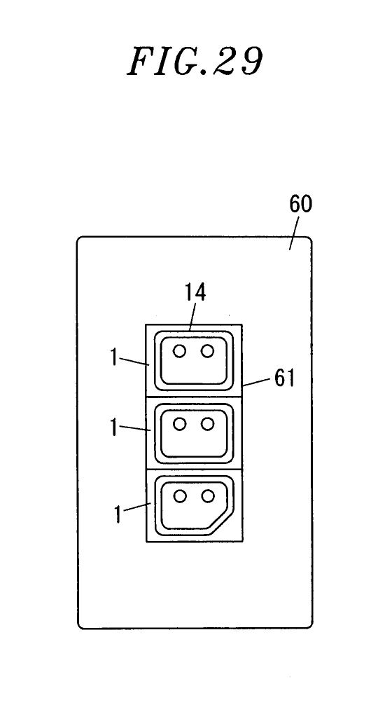

FIG. 29 shows an example of the installation of the DC outlet 1, where one DC outlet 1 of the SELV circuit and two DC outlets 1 of the ELV circuit are installed in the decoration frame 50. Meanwhile, in the plugs 2 of the SELV circuit and the ELV circuit to be connected to the corresponding DC outlets 1 of the present embodiment, the shape of the surrounding wall 23 to be engaged with the insertion groove 17 is changed to conform to the shape of the insertion groove 17 of the corresponding DC outlet 1.

As described above, in the DC outlet 1 of the ELV circuit, the plug-receiving portion 15 has the substantially quadrangular (rectangular) shape viewed from the front and the shape of the insertion groove 17 that surrounds the plug-receiving portion 15 is kept unchanged. On the contrary, in the DC outlet 1 of the SELV circuit, the shape of the insertion groove 17 is changed such that the area of the plug-receiving portion 15 is decreased as compared with the DC outlet 1 of the ELV circuit.

Accordingly, the plug 2 of the ELV circuit is connected to the DC outlet of the ELV circuit, while the plug 2 of the SELV circuit is connected to the DC outlet of the SELV circuit only without being connected to the DC outlet of the ELV circuit due to the interference between the surrounding wall 23 and the lower right corner of the plug-receiving portion 15. Therefore, it is possible to safely use an SELV device while preventing the SELV device requiring a lower insulation performance than that of an ELV device from being used in the ELV circuit having a lower insulation level than that of the SELV circuit.

Moreover, in the present embodiment, the shape of the insertion groove 17 is changed differently depending on the kinds of the power supply circuit by obliquely cutting at least one of four corners of the insertion groove 17. Accordingly, it is possible to easily recognize both the shape difference of the insertion groove 17 and/or the plug-receiving portion 15 and the orientation of the plug 2 to be inserted into the corresponding DC outlet 1. When the corner of the insertion groove 17 is cut, the shape of the insertion groove 17 is partially changed by obliquely cutting the corner in the present embodiment and, however, the corner may be cut into any shape. For example, as shown in FIG. 27C, the corner may substantially angularly be cut to form an angular recess 15h.

Besides, since the lower right corner of the insertion groove 17 is cut and the two pin-inserting holes 16 are arranged offset closer to the reference side (the upper side) opposite to the lower side of the insertion groove 17, it is possible to obtain a sufficient distance between the insertion groove 17 and the pin-inserting holes 16, to thereby suppress the strength of the plug-receiving portion 15 from being deteriorated.

Although the lower right corner of the insertion groove 17 is obliquely cut to change the shape of the insertion groove 17 in the present embodiment, other corner than the lower right corner may be cut. The shape of the insertion groove 17 may be changed by cutting the corner(s) on the reference side (the upper side) to which the pin-inserting holes 16 being arranged offset closer; or by cutting both left upper and the left lower corners to form the inclined sides 15a.

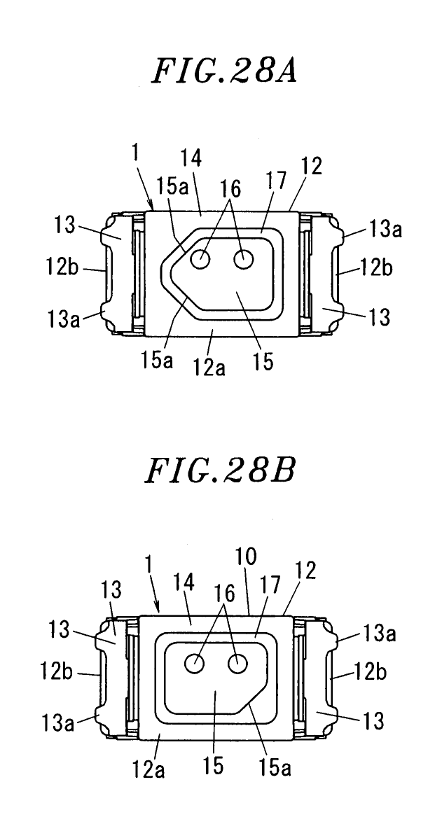

In the DC outlet 1 shown in FIGS. 27A to 28A, the shape of the insertion groove 17 viewed from the front is changed by cutting at least one corner of the insertion groove 17; and the outer peripheral shape of the insertion groove 17 is similar to the inner peripheral shape of the insertion groove 17. On the other hand, as shown in FIG. 28B, only the inner peripheral shape of the insertion groove may be changed by cutting the corner of the plug-receiving portion 15 while keeping the outer peripheral shape of the insertion groove 17 in the substantially quadrangular shape. This makes it easier to recognize the shape difference of the front surface of the plug-receiving portion 15 and the shape of the insertion groove 17.

### Ninth Embodiment

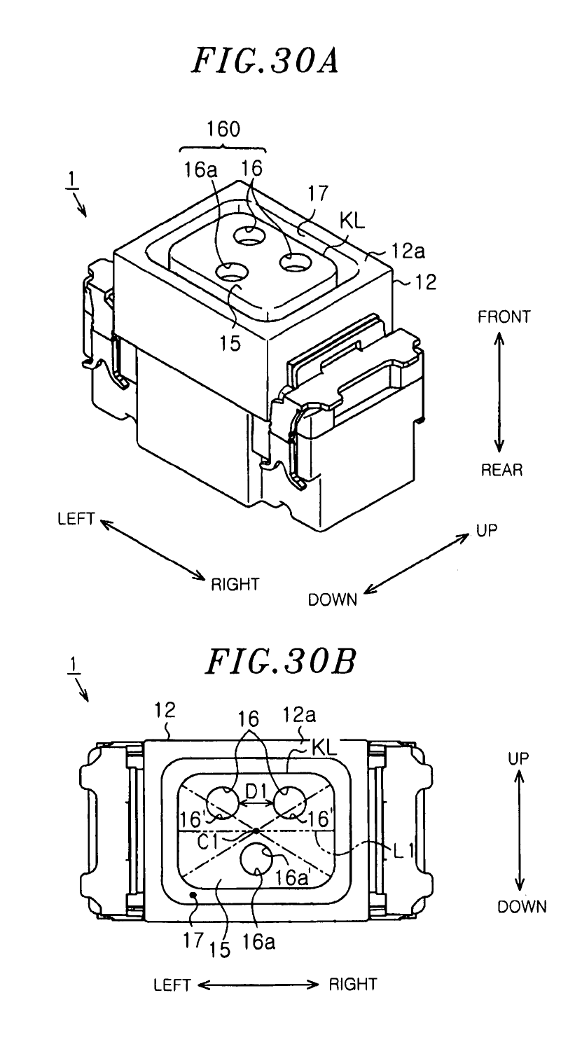

In the above embodiment, only the pin-inserting holes 16 into which the plug pins 22 of the plug 2 are inserted are provided in the plug-receiving portion 15. In a ninth embodiment of the present invention, the ground pin inserting hole 16a is further provided in addition to the pin-inserting holes 16 as shown in FIGS. 30A and 30B. The ground pin inserting hole 16a is provided at a central portion of the left-right direction Y below the central line L1. In such configuration, three pin-receiving pieces 18 in total are provided to correspond to the two pin-inserting holes 16 and one ground pin inserting hole 16a.

Specifically, referring to FIGS. 30A and 30B, pin holes 160 includes the two pin-inserting holes 16 arranged along the reference side KL serving as one side of the plug-receiving portion 15 extending in the left-right direction Y, i.e., an upper side of the plug-receiving portion 15; and one ground pin inserting hole 16a provided at an offset position closer to the opposite side to the reference side KL in the up-down direction Z than the pin-inserting holes 16. In other words, the ground pin inserting hole 16a is provided below the pin-inserting holes 16 in the up-down direction Z.

As shown in FIG. 30B, the pin inserting holes 16 are provided at an offset position closer to the reference side KL than the opposite side of the plug-receiving portion 15. In other words, the pin-inserting holes 16 are provided above the central point C1 (i.e., the intersection point of diagonal (dashed dotted) lines from each corner) of the plug-receiving portion 15 in the up-down direction Z; and at opposite sides, respectively, in the left-right direction Y with regard to the central point C1. Especially, lower end portions 16′ in the up-down direction Z of the pin-inserting holes 16 are arranged on the side of closer to the reference side KL above the (dashed double-dotted) central line L1 including the central point C1 or above the central line L1.

The ground pin inserting hole 16a is provided below the central point C1 in the up-down direction Z and at a central portion of the two pin-inserting holes 16 in the left-right direction Y. In other words, the ground pin inserting hole 16a is provided at a position corresponding to the central point C1 in the up-down direction Z. Especially, an upper end portion 16a′ of the ground pin-inserting hole 16a is provided below the central line L1.

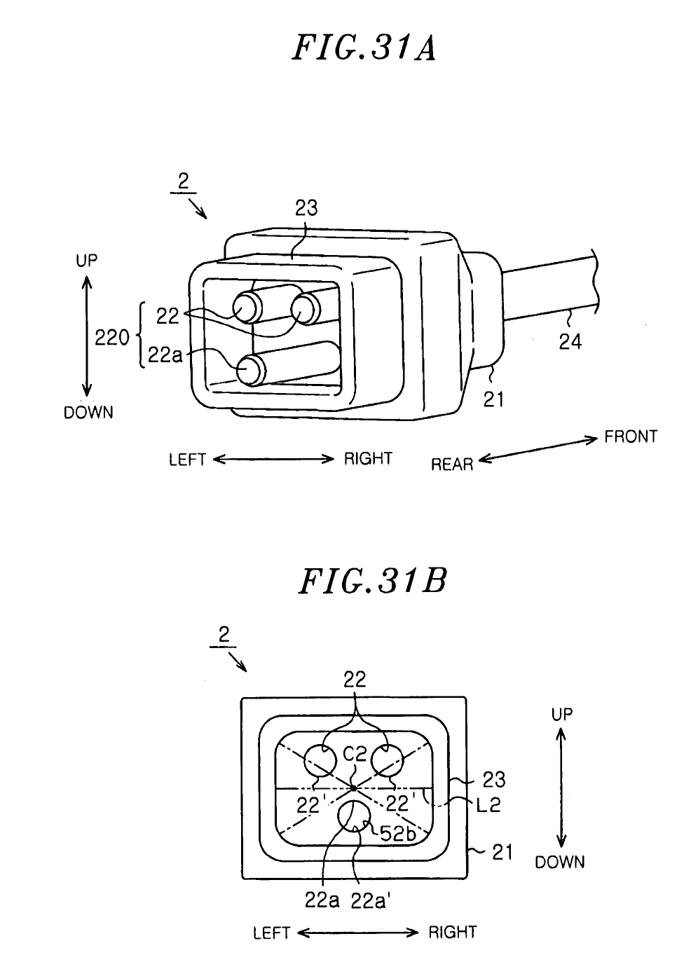

Next, the configuration of the plug 2 of the present embodiment will be described with reference to FIGS. 31A and 31B.

As shown in FIG. 31A, plug pins 220 includes the plug pins 22 arranged along one side of an outlet facing surface in the left-right direction of the FIGS. 31A and 31B; and one ground pin 22a provided below the plug pins 22.

The plug pins 22 are provided such that their leading ends are located backwardly of the leading end of the surrounding wall 23. The ground pin 22a is provided such that its leading end is located forwardly of the leading end of the surrounding wall 23.

As shown in FIG. 31B, the plug pins 22 are provided above the central point C2 (i.e., the intersection point of diagonal (dashed dotted) lines from each corner) of the surrounding wall 23 in the up-down direction; and at opposite sides, respectively, in the left-right direction with regard to the central point C2. Especially, lower end portions 22′ in the up-down direction of the plug pins 22 are arranged above the (dashed double-dotted) central line L2 including the central point C2.

The ground pin 22a is provided below the central point C2 in the up-down direction and at a central portion of the two plug pins 22 in the left-right direction (i.e., at a position corresponding to the central point C2 in the up-down direction). Especially, an upper end portion 22a′ of the ground pin 22a is provided below the central line L2.

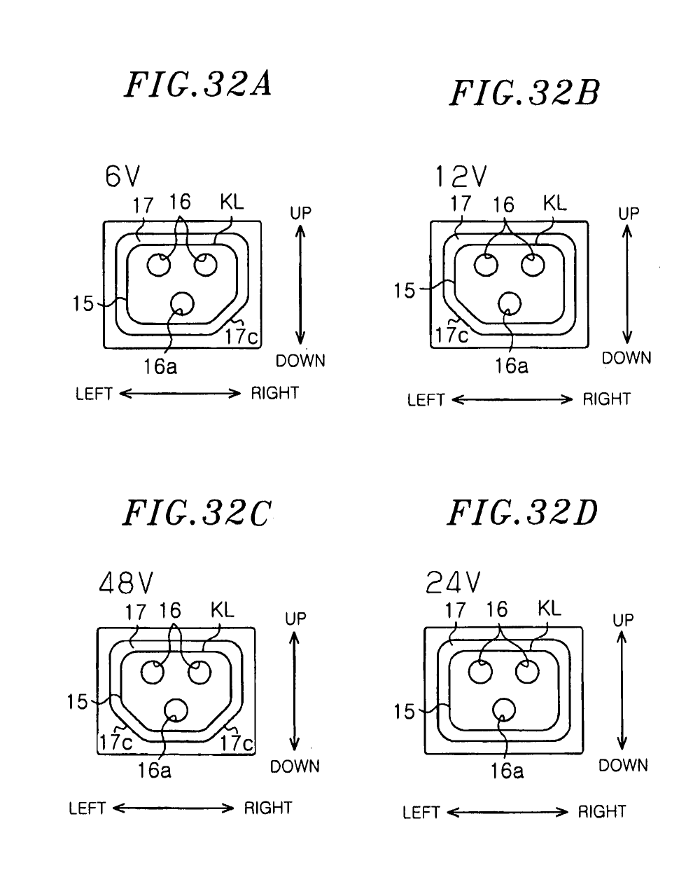

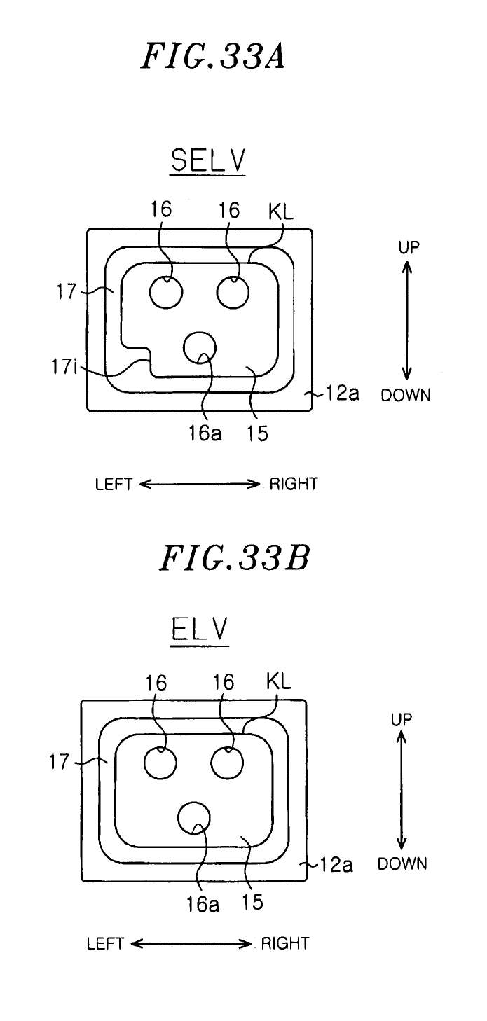

FIGS. 32A to 32D show examples of the shape of the insertion groove 17 that is changed depending on the kinds of the supply voltage, and FIGS. 33A and 33B show examples of the shape of the insertion groove 17 that is changed depending on the kinds of the power supply circuit. Since the shape of the insertion groove 17 that is changed depending on the kinds of the supply voltage and the power supply circuit has already been described in the above embodiments, redundant description thereof will be omitted in the present embodiment.

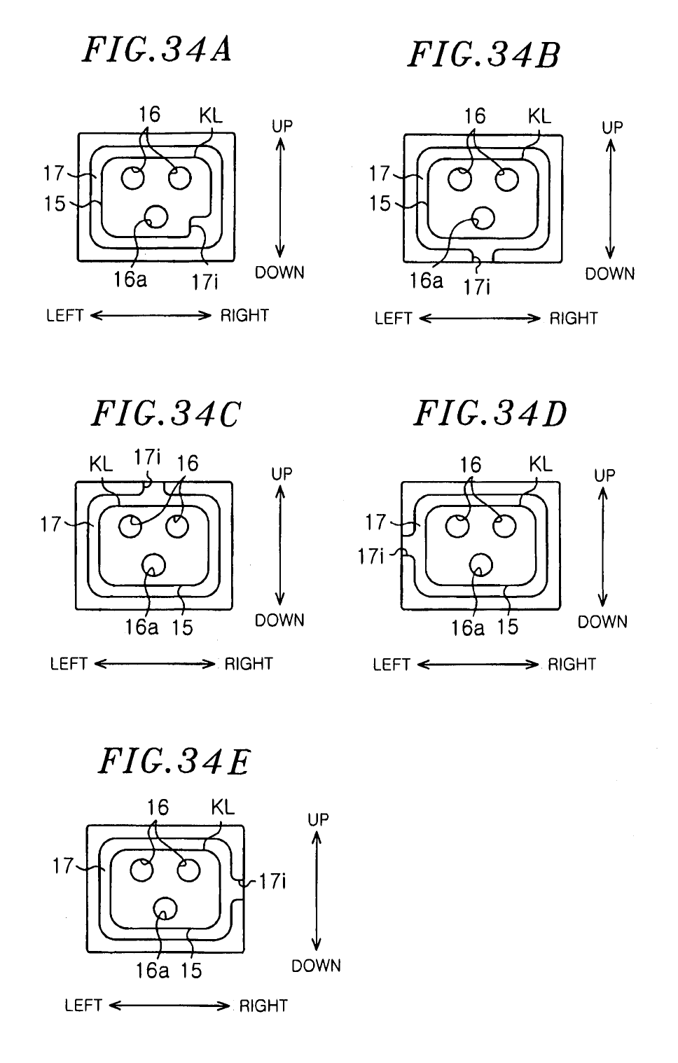

Although an extension groove 17i is provided at the lower left corner of the insertion groove 17 in FIG. 33A, the position of the extension groove 17i is not limited thereto. For example, as shown in FIG. 34A, the extension groove 17i may be provided at the lower right corner of the insertion groove 17.

The extension groove 17i may be provided at any one of the four corners of the insertion groove 17 without being limited to the lower left and right corners of the insertion groove 17.

Further, the extension groove 17i is provided in the plug-receiving portion 15 in the present embodiment, but is not limited thereto. For example, the extension groove 17i may be provided to extend from the lower side of the insertion groove 17 downwardly as shown in FIG. 34B or to extend from the upper side of the insertion groove 17 upwardly as shown in FIG. 34C. Alternatively, the extension groove 17i may be provided to extend from the left side of the insertion groove 17 to the left as shown in FIG. 34D or to extend from the right side of the insertion groove 17 to the right as shown in FIG. 34E.

In the present embodiment, the inclined groove 17c is provided at one corner or both corners of the lower side of the insertion groove 17 to identify the kinds of the supply voltage of the DC outlet 1. However, such configuration for identifying the kinds of the supply voltage is not limited thereto. If the shape of the insertion groove 17 is changed such that the insertion groove 17 can be inserted into the surrounding wall 23 of the plug 2 only when the supply voltage of the plug 2 corresponds to the voltage supplied from the DC outlet 1, it is sufficient to use the shape of the insertion groove 17.

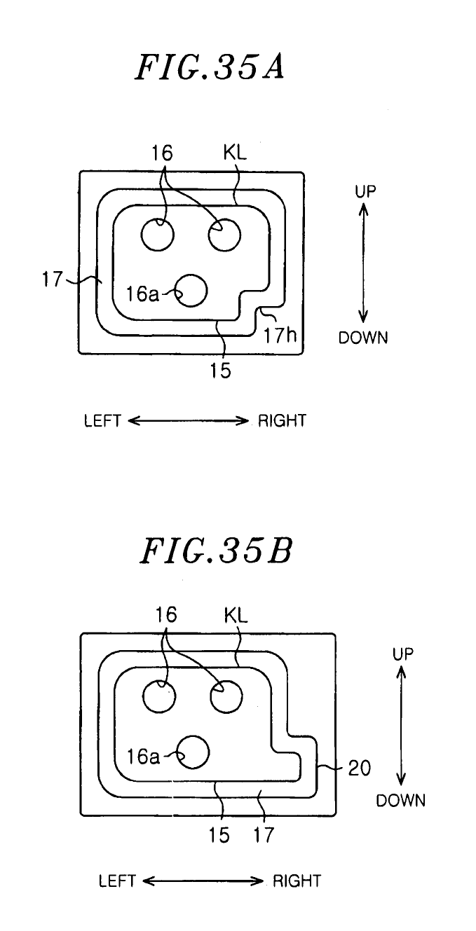

Accordingly, a step-shaped recess 17h may be provided by cutting one corner of the insertion groove 17 as shown in FIG. 35A, for example. Further, as shown in FIG. 35B, the extension groove 20 may be provided by protruding a part of the insertion groove 17 outwardly. Meanwhile, the surrounding wall 23 of the plug 2 is formed to have the same shape as that of the insertion groove 17, viewed from the front.

Although the inclined groove 17c is provided at the lower side of the insertion groove 17 in the present embodiment, the inclined groove 17c may be provided at the upper side of the insertion groove 17.

In the present embodiment, the lower end portion 16′ of the pin-inserting holes 16 is provided above the central point C1 of the plug-receiving portion 15. However, the position of the lower end portion 16′ is not limited thereto. The lower end portion 16′ may be provided such that the plug pins 22 are not inserted into the pin-inserting holes 16 when the plug 2 is reversely inserted into the DC outlet 1. Accordingly, the lower end portion 16′ may be provided at a substantially same position as that of the central point C1.

While the invention has been shown and described with respect to the embodiments, it will be understood by those skilled in the art that various changes and modifications may be made without departing from the scope of the invention as defined in the following claims.

What is claimed is:

1. A direct current (DC) outlet to which a plug is adapted to be connected to supply a DC power to the plug, the plug including a plurality of plug pins having a circular bar shape; and a substantially quadrangular-shaped surrounding wall for surrounding the plug pins, the DC outlet comprising:
an outlet main body having an outlet unit to which the plug is adapted to be connected, the outlet unit being provided in a front surface of the outlet main body,
wherein the outlet unit includes a plug-receiving portion having a plurality of pin-inserting holes into which the plug pins of the plug are inserted, the plug-receiving portion having a substantially quadrangular shape viewed from the front thereof; an insertion groove formed to surround a periphery of the plug-receiving portion, the insertion groove being adapted to receive the surrounding wall of the plug; and pin-receiving pieces for being connected with the plug pins that are respectively inserted through the pin-receiving holes,
wherein two of the pin-receiving holes corresponding to the pin-receiving pieces for supplying a DC power are arranged along one side of the plug-receiving portion serving as a reference side and offset closer to the reference side than an opposite side to the reference side.

2. The DC outlet of claim 1, wherein a shape of at least one of the plug-receiving portion and the insertion groove, viewed from the front thereof, is partially changed depending on the kinds of a supply voltage or a supply current.

3. The DC outlet of claim 2, wherein the shape of the insertion groove viewed from the front is changed such that an area of the plug-receiving portion is decreased as compared with a case that the plug-receiving portion has the substantially quadrangular shape viewed from the front.

4. The DC outlet of claim 3, wherein the shape of the insertion groove viewed from the front is changed differently depending on the kinds of the supply voltage or the supply current by cutting at least one corner of the substantially quadrangular shape of the plug-receiving portion depending on the kinds of the supply voltage or the supply current, and forming the insertion groove along an outer periphery of the plug-receiving portion.

5. The DC outlet of claim 2, wherein a portion of the insertion groove whose shape is changed depending on the kinds of the supply voltage or the supply current is closer to the opposite side to the reference side than the reference side.

6. The DC outlet of claim 2, wherein the shape of the insertion groove viewed from the front is changed such that an area of the plug-receiving portion is increased as compared with a case that the plug-receiving portion has the substantially quadrangular shape viewed from the front.

7. The DC outlet of claim 2 or 4, wherein the shape of the insertion groove viewed from the front is partially changed by forming an extension groove extending from the insertion groove.

8. The DC outlet of claim 7, wherein the extension groove is formed by extending a part of the insertion groove into the plug-receiving portion.

9. The DC outlet of claim 7, wherein the extension groove is provided closer to the opposite side to the reference side of the plug-receiving portion than the reference side.

10. The DC outlet of claim 7, wherein the extension groove is formed on the front surface of the outlet main body by outwardly extending a part of the insertion groove.

11. The DC outlet of claim 1, wherein a shape of at least one of the plug-receiving portion and the insertion groove, viewed from the front thereof, is partially changed depending on the kinds of a power supply circuit serving as a power supply source.

12. The DC outlet of claim 11, wherein the shape of the insertion groove viewed from the front is changed such that an area of the plug-receiving portion is decreased as compared with a case that the plug-receiving portion has the substantially quadrangular shape viewed from the front.

13. The DC outlet of claim 12, wherein the shape of the insertion groove viewed from the front is changed differently depending on the kinds of the power supply circuit by cutting at least one corner of the substantially quadrangular shape of the plug-receiving portion depending on the kinds of the power supply circuit, viewed from the front, and forming the insertion groove along an outer periphery of the plug-receiving portion.

14. The DC outlet of claim 11, wherein a portion of the insertion groove whose shape is changed depending on the kinds of the power supply circuit is closer to the opposite side to the reference side than the reference side.

15. The DC outlet of claim 11, wherein the shape of the insertion groove viewed from the front is changed such that an area of the plug-receiving portion is increased as compared with a case that the plug-receiving portion has the substantially quadrangular shape viewed from the front.

16. The DC outlet of claim 11 or 13, wherein the shape of the insertion groove viewed from the front is partially changed by forming an extension groove extending from the insertion groove.

17. The DC outlet of claim 16, wherein the extension groove is formed by extending a part of the insertion groove into the plug-receiving portion.

18. The DC outlet of claim 16, wherein the extension groove is provided closer to the opposite side to the reference side of the plug-receiving portion than the reference side.

19. The DC outlet of claim 16, wherein the extension groove is formed on the front surface of the outlet main body by outwardly extending the insertion groove.

20. The DC outlet of claim 11, wherein the shape of the insertion groove viewed from the front is partially changed only when the power supply circuit is a safety extra low voltage (SELV) circuit.

21. The DC outlet of claim 1, wherein the plug pins of the plug include a ground pin, and the pin-inserting holes of the plug-receiving portion include a ground pin inserting hole into which the ground pin of the plug is inserted.

22. The DC outlet of claim 21, wherein the ground pin inserting hole is provided offset closer to the opposite side to the reference side.
